(19) United States
(12) Patent Application Publication
(10) Pub. No.: US 2026/0349324 A1
(43) Pub. Date: Nov. 5, 2026

(54) AMBIENT IMAGE PROJECTION DEVICE

(71) Applicants: ZHONGSHAN YONGQI ELECTRONIC TECHNOLOGY CO., LTD., ZHONGSHAN (CN); ZHONGSHAN BOLONG ELECTRONIC TECHNOLOGY CO.,LTD., ZHONGSHAN (CN); ZHONGSHAN JIAEN OPTOELECTRONICS CO.,LTD., ZHONGSHAN (CN)

(72) Inventors: SHAOQI JI, ZHONGSHAN (CN); KEXIAN LIU, ZHONGSHAN (CN); BO LI, ZHONGSHAN (CN); YONG HUANG, ZHONGSHAN (CN); GANG WANG, ZHONGSHAN (CN); JING LI, ZHONGSHAN (CN)

(21) Appl. No.: 19/730,918

(22) Filed: Jul. 3, 2026

Related U.S. Application Data
(63) Continuation-in-part of application No. 19/358,841, filed on Oct. 15, 2025, now Pat. No. 12,675,037.
Application No. 19/358,841 is a continuation-in-part of application No. 18/562,333, filed on Jun. 11, 2022, now Pat. No. 12,498,632.

(30) Foreign Application Priority Data
Jan. 19, 2022 (CN) 202210061417.3

(51) Int. Cl. G03B 21/53; G03B 21/16

(52) U.S. Cl. CPC G03B 21/53; G03B 21/16

(57) ABSTRACT

An ambient image projection device includes a lens assembly, a projection assembly, and a focusing assembly. The projection assembly includes a first light source and a display screen; content played on the display screen is capable of forming a dynamic image under guidance of the lens assembly and projecting the dynamic image into space. The focusing assembly is configured to be drivable both manually and automatically, so as to drive at least a portion of lenses in the lens assembly to move along an optical path direction, thereby focusing the dynamic image. The first light source, the display screen, and the lens assembly are sequentially arranged along an optical path of the ambient image projection device, and the display screen is arranged on a light-exiting side of the first light source.

### CROSS-REFERENCE TO RELATED APPLICATIONS

The present disclosure is a continuation in part of a pending non-provisional application No. 19/358,841, filed on Oct. 15, 2025, which is a continuation in part of a pending non-provisional application No. 18/562,333 filed on Nov. 20, 2023, which is a national stage of an international application No. PCT/CN2022/098282 filed on Jun. 11, 2022, which claims a priority to Chinese Patent Application No. 202210061417.3 filed on Jan. 19, 2022. The contents of above applications are incorporated herein by reference in their entireties.

### FIELD

The subject matter herein generally relates to projection lamps, and particularly to an ambient image projection device.

### BACKGROUND

An ambient lamp is a type of lighting device capable of projecting patterns onto walls, floors, or screens. These lamps are commonly used in stage entertainment settings such as theaters, studios, bars, and discos, where they can project monochromatic or multicolored patterns like water waves, starry skies, or various lines, thereby creating a warm, romantic, and immersive ambiance.

With continuous progress and development of society, people's living standards have steadily improved, and ambient lamps have gradually found their way into countless households. Traditional ambient image projection devices typically rely on a light source passing through a decorative cover printed with patterns to achieve pattern projection. To enhance projection effects, some existing ambient lamps incorporate one or more rotating water ripple discs relative to the light source, allowing light to pass through a focusing lens before projecting images. This approach creates diverse effects such as flowing galaxies or undulating water waves.

For example, U.S. Patent No. US8057045B2 discloses a projection method and device that uses a motor-driven interference wheel to achieve dynamic starry sky and cloud transformation effects. Chinese Patent No. CN207796894U reveals a water ripple projection lamp that utilizes multiple focusing layers of water ripple glass shading cloth and axial reciprocating motion to produce water ripple projection effects. Similarly, Chinese Patent No. CN210891354U introduces a three-in-one starry sky lamp structure that achieves dynamic projections of stars, moons, and clouds through a combination of water ripple discs and projection devices.

In these existing technical solutions, use of motors and interference discs enables dynamic projection effects. However, the projected images exhibit periodic changes, which may lead to aesthetic fatigue over prolonged viewing. To address this problem, a static image projection can be superimposed onto the dynamic interference imagery as a background, creating a more three-dimensional visual effect. Nevertheless, such ambient lamps typically rely on slide-based presentations, often requiring manual image switching—a cumbersome process. Additionally, images are usually projected using film slides; while more slides offer greater scene variety, they also increase costs.

Furthermore, an optical path structure of projection devices significantly impacts projection quality of ambient images.

### SUMMARY

In order to solve above deficiencies in existing technologies, the present disclosure aims to provide an ambient image projection device.

An ambient image projection device includes a lens assembly, a projection assembly, and a focusing assembly. The projection assembly includes a first light source and a display screen; content played on the display screen is capable of forming a dynamic image under guidance of the lens assembly and projecting the dynamic image into space. The focusing assembly is configured to be drivable both manually and automatically, so as to drive at least a portion of lenses in the lens assembly to move along an optical path direction, thereby focusing the dynamic image. The first light source, the display screen, and the lens assembly are sequentially arranged along an optical path of the ambient image projection device, and the display screen is arranged on a light-exiting side of the first light source.

Comparing with ambient image projection devices in existing technologies, the present disclosure projects images via a display screen, eliminating the need for a film and thus reducing costs. Moreover, the display screen can offer a more diverse and abundant range of image options, with seamless image switching and convenient operation, significantly enhancing the user experience. In addition, the focusing assembly configured to be drivable both manually and automatically is connected to the lens assembly. The focusing assembly drives at least a portion of the lenses inside the lens assembly to physically move along the optical path direction, thereby changing the image distance and achieving precise focusing of the dynamic image. This enables the device to project clear, high-definition images at any projection distance (whether onto a low wall or a high ceiling), thus enhancing the user experience.

### BRIEF DESCRIPTION OF THE DRAWINGS

FIG. 1 is a schematic structural diagram of an ambient image projection device a first embodiment of the present disclosure.

FIG. 2 is a schematic structural diagram of an ambient image projection device a second embodiment of the present disclosure.

FIG. 3 is a schematic structural diagram of an ambient image projection device a third embodiment of the present disclosure.

FIG. 4 is a schematic structural diagram of an ambient image projection device a fourth embodiment of the present disclosure.

FIG. 5 is a schematic structural diagram of an ambient image projection device a fifth embodiment of the present disclosure.

FIG. 6 is a schematic structural diagram showing a basic optical path of the ambient image projection device provided by the fifth embodiment of the present disclosure.

FIG. 7 is an exploded view of an ambient image projection device according to a sixth embodiment of the present disclosure.

FIG. 8 is a schematic structural diagram of a Fresnel lens used in a projection assembly of the ambient image projection device in the sixth embodiment of the present disclosure.

FIG. 9 is a schematic structural diagram of a light-concentrating element used in the projection assembly of the ambient image projection device in the sixth embodiment of the present disclosure.

FIG. 10 is a schematic structural diagram of a light source used in the projection assembly of the ambient image projection device in the sixth embodiment of the present disclosure.

FIG. 11 is a schematic structural diagram showing assembling of a fixed base member and a moveable lens barrel in an optical engine housing of the ambient image projection device in the sixth embodiment of the present disclosure.

FIG. 12 is a schematic structural diagram of an optical engine housing of the ambient image projection device in the sixth embodiment of the present disclosure.

FIG. 13 is a schematic structural diagram of the optical engine housing of the ambient image projection device in the sixth embodiment of the present disclosure from another view.

FIG. 14 is an exploded view of a first cooling fan in the ambient image projection device in the sixth embodiment of the present disclosure.

FIG. 15 is an exploded view of the first cooling fan in the ambient image projection device in the sixth embodiment of the present disclosure from another view.

FIG. 16 is a cross-sectional view of the ambient image projection device in the sixth embodiment of the present disclosure.

FIG. 17 is a cross-sectional view of the ambient image projection device in the sixth embodiment of the present disclosure from another view.

FIG. 18 is a schematic structural diagram of a heat-dissipation member of the ambient image projection device in the sixth embodiment of the present disclosure.

FIG. 19 is an exploded view of an ambient image projection device according to a seventh embodiment of the present disclosure.

FIG. 20 is an exploded view of the ambient image projection device in the seventh embodiment of the present disclosure from another view.

FIG. 21 is an exploded view of an ambient image projection device according to an eighth embodiment of the present disclosure.

FIG. 22 is an exploded view of the ambient image projection device in the eighth embodiment of the present disclosure from another view.

FIG. 23 is an exploded view of an ambient image projection device according to a nineth embodiment of the present disclosure.

FIG. 24 is an exploded view of the ambient image projection device in the nineth embodiment of the present disclosure from another view.

FIG. 25 is an exploded view of an ambient image projection device according to a tenth embodiment of the present disclosure.

FIG. 26 is an exploded view of an ambient image projection device according to an eleventh embodiment of the present disclosure.

FIG. 27 is an exploded view of an ambient image projection device according to a twelfth embodiment of the present disclosure.

FIG. 28 is an exploded view of an ambient image projection device according to a thirteenth embodiment of the present disclosure.

FIG. 29 is an exploded view of an ambient image projection device according to a variant embodiment of the thirteenth embodiment of the present disclosure.

FIG. 30 is a schematic structural diagram of an ambient image projection device according to a fourteenth embodiment of the present disclosure.

FIG. 31 is a schematic structural diagram of the ambient image projection device in FIG. 30 from another view.

FIG. 32 is an exploded view of the ambient image projection device in FIG. 30.

FIG. 33 is an exploded view of the ambient image projection device in FIG. 30 from another view.

FIG. 34 is a schematic diagram showing separation of a main housing and a base of the ambient image projection device shown in FIG. 30.

FIG. 35 is a partial sectional view illustrating assembly of the main housing and the base of the ambient image projection device shown in FIG. 30.

FIG. 36 is a schematic diagram of the ambient image projection device shown in FIG. 30 from another angle.

FIG. 37 is a schematic diagram illustrating a projection ratio of the ambient image projection device shown in FIG. 30.

FIG. 38 is a schematic diagram showing a projected image of the ambient image projection device shown in FIG. 30.

FIG. 39 is a schematic diagram explaining a range of the projection ratio for the ambient image projection device shown in FIG. 30.

FIG. 40 is a schematic exploded view of the optical path and the focusing assembly of the ambient image projection device according to Embodiment 15 of the present disclosure.

FIG. 41 is a schematic exploded view of a partial structure of the focusing assembly of the ambient image projection device according to Embodiment 15 of the present disclosure.

FIG. 42 is a cross‑sectional view of a partial structure of the focusing assembly of the ambient image projection device according to Embodiment 15 of the present disclosure.

FIG. 43 is a schematic exploded view of a partial structure of the heat dissipation system of the ambient image projection device according to Embodiment 15 of the present disclosure.

FIG. 44 is a schematic exploded view of the optical engine housing and internal components of the ambient image projection device according to Embodiment 15 of the present disclosure.

FIG. 45 is a schematic exploded view of the fixing frame bracket and the display screen of the ambient image projection device according to Embodiment 15 of the present disclosure.

FIG. 46 is a schematic diagram of the main housing separated from the base of the ambient image projection device according to Embodiment 15 of the present disclosure.

FIG. 47 is a schematic diagram of the main housing separated from the base of the ambient image projection device according to Embodiment 15 of the present disclosure, from another perspective.

FIG. 48 is a structural control block diagram of the ambient image projection device according to Embodiment 15 of the present disclosure.

### DETAILED DESCRIPTION

The inventors of the present disclosure have discovered that in existing technical solutions, motors are universally employed to drive rotation of light-transmitting structures, thereby achieving motion changes in projected images. However, the projected images exhibit periodic variations, which may lead to aesthetic fatigue over long-time viewing. Additionally, the methods for switching projected images are rigid, making it difficult to create relatively impactful scenes.

In light of this, the present disclosure provides an ambient image projection device capable of rendering more realistic and diverse dynamic scenes to enhance user experience.

### Embodiment 1

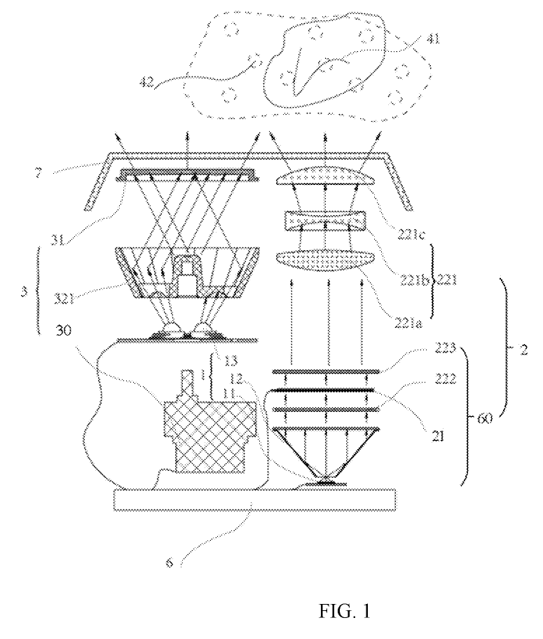

The first embodiment of the present disclosure provides an ambient image projection device. As illustrated in FIG. 1, the ambient image projection device includes: a first projection mechanism 2 and a second projection mechanism 3 arranged in parallel with the first projection mechanism 2.

The first projection mechanism 2 includes: a projection assembly 60 and a lens assembly 221. The projection assembly 60 includes a first light source 11 and a display screen 21. The content displayed on the display screen 21 forms dynamic images 41 under guidance of the lens assembly 221 and projects the dynamic images 41 into space.

The second projection mechanism 3 includes: a second light source 13, an interference lens 31, and an optical path module. Light emitted from the second light source 13 passes through the interference lens 31 under the guidance of the optical path module, forming interference patterns 42 that are projected into space.

The interference patterns 42 and the dynamic images 41 at least partially overlap in space.

The content displayed on the display screen 21 forms dynamic images 41 projected into space, while light from the second light source 13 passes through the interference lens 31 to create the interference patterns 42 projected into space. The interference patterns 42 (indicated by dashed lines in FIG. 1) and the dynamic images 41 at least partially overlap in space. The interference patterns cover a large area, thus providing a more expansive dynamic visual experience. By projecting images via the display screen 21, the need for film slides is eliminated, reducing costs. Furthermore, the display screen 21 offers a richer variety of image options with seamless switching and convenient operation. Compared to existing technologies, this embodiment uses the combination of the interference patterns 42 and the dynamic images 41 to address limitations of narrow visual coverage in dynamic images 41 and monotony caused by limited variations in interference patterns 42. The complementary integration of the dynamic images 41 and the interference patterns 42 significantly enhances user experience.

In the embodiment, the display screen 21 can be a liquid crystal display (LCD) screen, which offers advantages such as low power consumption, compact size, and zero radiation. The light emitted from the first light source 11 can illuminate the display screen 21, serving as a backlight. In another embodiment, the display screen 21 can be a self-emissive display, such as an LED display or an OLED display, as long as it is capable of forming dynamically displayed content.

The projection assembly 60 may further include a plurality of lenses and a light-concentrating element 12. The first light source 11, the light-concentrating element 12, the display screen 21, and the lens assembly 221 are sequentially positioned along an optical path defined by first projection mechanism 2. The plurality of optical lenses arranged among components of the projection assembly 60. The cooperation of the lens assembly 221, the plurality of optical lenses, and the light-concentrating element 12 enables the projected dynamic images 41 to be clearer and more efficient in light output.

To enhance imaging clarity, the plurality of optical lenses can be convex lenses that can converge light. However, if ordinary convex lenses are employed, since light refraction occurs only at an interface between media and convex lenses are relatively thick, light attenuation may occur during light transmitting, leading to dimming and blurring at edges. Therefore, in the embodiment, Fresnel lenses can be used as the optical lenses. One surface of a Fresnel lens is smooth, while the other surface is etched with concentric circles of increasing sizes. Its texture is designed based on principles of light interference, diffraction, as well as requirements for relative sensitivity and reception angles. Consequently, Fresnel lenses eliminate the need for straight-line light propagation and retain only curved surfaces where refraction occurs, significantly reducing material usage while achieving the same light-converging effect as convex lenses. In other words, Fresnel lenses offer much lower costs compared to ordinary convex lenses.

The plurality of lenses include: a first lens 222 arranged between the light-concentrating element 12 and the display screen 21; a second lens 223 arranged between the display screen 21 and the lens assembly 221. The lens assembly 221 may include: a first convex lens 221a, a first concave lens 221b, and a second convex lens 221c arranged sequentially, with the first convex lens 221a positioned adjacent to the display screen 21.

The first lens 222 and the second lens 223 are designed to better converge light and prevent wastage of light energy. The first convex lens 221a converges light, while the first concave lens 221b diverges light. Therefore, by designing the parameters of the first convex lens 221a and the first concave lens 221b, the projection effect of the images, such as the size of the image and its distance, the focusing range, and image quality, can be well ensured. In this embodiment, the second convex lens 221c can be a fisheye lens, which, as a wide-angle lens, enables the lens to achieve a maximum photographic viewing angle. Thus, it can project a larger space within confined environment of the ambient image projection device, improving spatial utilization of the device.

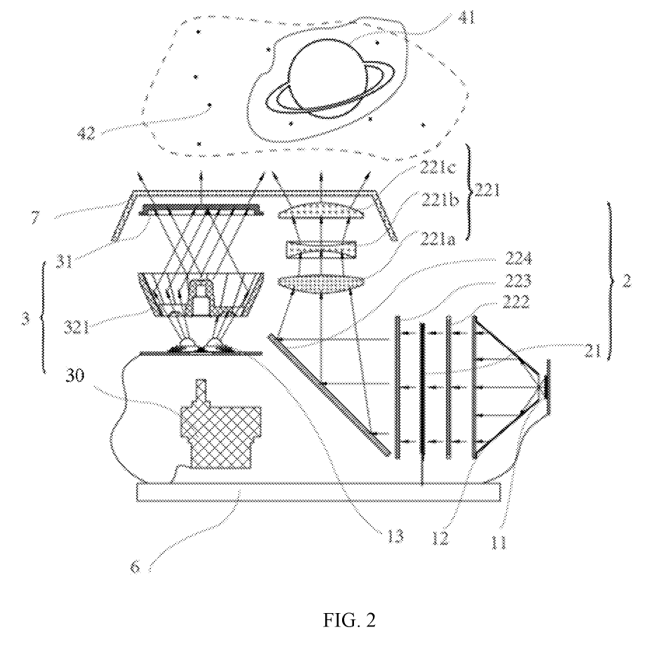

In another embodiment, as shown in FIG. 2, the projection assembly 60 may further include a reflective mirror 224 positioned between the second lens 223 and the lens assembly 221. The reflective mirror 224 is arranged at an angle to the display screen 21. When the reflective mirror 224 is positioned at an angle to the display screen 21, it can alter a direction of light propagation, enabling light emitted from the second lens 223 to be reflected by the reflective mirror 224 and then incident onto the lens assembly 221. Optionally, the reflective mirror 224 may be set at a 45° angle to the display screen 21, causing the light emitted from the second lens 223 to be perpendicular to the light incident onto the optical lens 221.

By comparing FIGS. 1 and 2, it can be observed that if the optical lenses and the reflective mirror 224 are of the same size, dimensions of components such as the lens assembly 221 in the embodiment shown in FIG. 2 can be relatively smaller. Similarly, if the dimensions of components like the lens assembly 221 in the embodiment are the same with that in the embodiment in FIG. 1, the sizes of the lenses and the reflective mirror 224 in the embodiment can be smaller than that in the embodiment in FIG. 1. In other words, due to incorporation of the reflective mirror 224, this embodiment further enhances the spatial utilization efficiency of the ambient image projection device.

The optical path module may include: a reflective cup 321 positioned between the second light source 13 and the interference lens 31. A reflective surface on an inner wall of the reflective cup 321 consists of a plurality of light-reflective planes. Light incident onto the reflective surface can be reflected off these multiple planes, creating numerous intersecting light rays. Thus, the reflective cup 321 can guide the light emitted from the second light source 13 to the interference lens 31, resulting in clearer projected interference patterns 42 with an improved light output efficiency.

As is well understood by those skilled in the art, in physics, interference occurs when two or more waves overlap in space, leading to superposition or cancellation to form new waveforms. For example, when a monochromatic light beam is split into two beams using a beam splitter and then allowed to overlap in a certain region of space, it is observed that the light intensity in the overlapping region is not uniformly distributed. The brightness varies with positions in space. The brightest areas exceeding a sum of intensities of the original two beams, while the darkest areas may have zero intensity. This redistribution of light intensity is referred to as "interference fringes."

The interference lens 31 can be a transparent water-ripple sheet or a light-transmissive, refractive sheet structure having a water-ripple pattern. Its material can be glass, resin, PC, etc., and a specific choice does not impose any limitations on the present disclosure. Due to an uneven surface of the interference lens 31, optical path differences of refracted light rays vary, causing coherent light rays to superimpose and resulting in alternating bright and dark interference fringes.

In the embodiment, the interference lens 31 or the reflective cup 321 can be rotated 360° by a motor 30 to project dynamic interference patterns 42 in space, achieving effects such as flowing stars or rippling water, thereby enhancing the user experience. For example, the motor 30 can drive rotation of the interference lens 31 while the reflective cup 321 remains stationary, or vice versa, the motor 30 can drive rotation of the reflective cup 321 while the interference lens 31 remains stationary.

The first light source 11 and the second light source 13 are collectively referred to as the light source assembly 1. In some embodiments, there are multiple second light sources 13, and the multiple second light sources correspond to the reflector cup 321. Light emitted from the plurality of second light sources 13 enters the reflective cup 321 and then passes through the interference lens 31 to produce distinct interference patterns 42. These second light sources 13 can be sequentially turned on and off to project dynamic interference patterns 42 in space. The second light sources 13 of different colors and intensities can introduce more variations in the projected interference patterns 42, improving the projection effects of the ambient image projection device.

The second light source 13 employed in the present disclosure can be either a monochromatic light source or an RGB light source, namely a multicolored light source. The first light source 11 used in the present disclosure preferably emits white light. Compared to light sources of other colors, white light does not affect warm or cool tones of the image colors when projected onto the display screen 21, enabling a more accurate representation of the image colors.

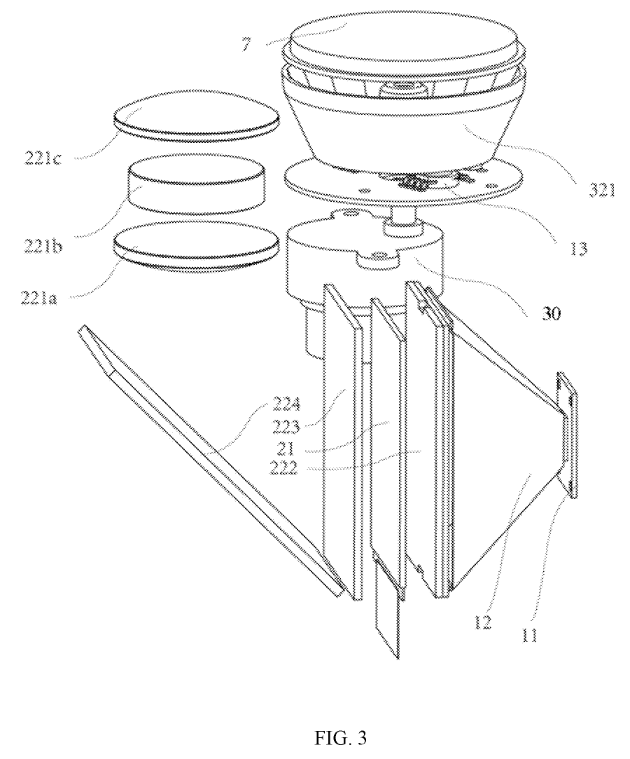

In the embodiment, as shown in FIGS. 2 and 3, the light emitted by the monochromatic or multicolored second light source 13 is reflected by the reflective cup 321. The reflective cup 321 can be fixed to the motor 30 using three reinforcing ribs, which allows the reflected light to rotate along with the motor 30 and project patterns onto the interference lens 31 with striped or uneven surfaces.

The light emitted by the first light source 11 is collected by the light-concentrating element 12 and then projected onto the first lens 222, which redirects it onto the liquid crystal display screen 21 as backlight. The content on the display screen 21 undergoes a first 3D conversion via the second lens 223, followed by a second conversion through the first convex lens 221a and the first concave lens 221b, and is finally imaged through the second convex lens 221c.

The images projected by the second projection mechanism 3 and the first projection mechanism 2 undergo refraction through an irregular dust-proof and light-transmissive cover 7, and finally form dynamic images 41 and interference patterns 42 projected into space. For example, the interference pattern 42 may appear as a rotating night sky, while the dynamic image 41 could be a rotating Saturn. The interference pattern 42 and dynamic image 41 at least partially overlap in space, resulting in a dynamic image with Saturn as the foreground and the night sky as the background. Therefore, this embodiment provides the ambient image projection device with a wide-angle view and a stereoscopic effect, smooth image playback, diverse image selection, a compact structure, and low cost, thus significantly enhancing the user experience.

It is worth mentioning that the first projection mechanism 2 and the second projection mechanism 3 of the ambient image projection device in this embodiment can be used independently or in combination according to user needs.

### Embodiment 2

The second embodiment of the present disclosure proposes an ambient image projection device, which differs from the first embodiment primarily in that: in the first embodiment, the first projection mechanism 2 and the second projection mechanism 3 are connected to separate light sources, whereas in the second embodiment, they are connected to the same light source.

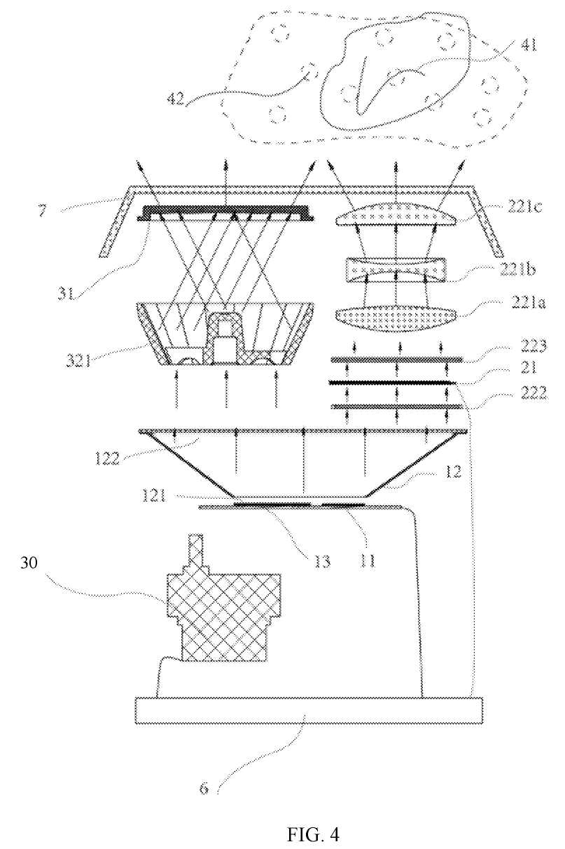

Specifically, as shown in FIG. 4, the light-concentrating element 12 includes a light entrance 121 and a light exit 122. Both the display screen 21 and the reflective cup 321 are arranged at the exit of the light-concentrating element 12.

The light emitted by both the first light source 11 and the second light source 13 enters the light-concentrating element 12 through the light entrance 121.

After being collected by the light-concentrating element 12, part of the light from the first light source 11 and the second light source 13 is reflected by the reflective cup 321 and projects patterns onto the interference lens 31 with striped or uneven surfaces. Another part of the light is projected onto the first lens 222 and redirected onto the liquid crystal display screen 21 as backlight. The content on the display screen 21 undergoes a first 3D conversion via the second lens 223, followed by a second conversion through the first convex lens 221a and the first concave lens 221b, and is finally imaged through the second convex lens 221c. In one embodiment, the first light source 11 and the second light source 13 can be mounted on the motor 30 and rotated under the motor’s driving. Alternatively, the first light source 11 and the second light source 13 can be the same light source, providing light for both the reflective cup 321 and the display screen 21.

The images projected by the second projection mechanism 3 and the first projection mechanism 2 undergo refraction through the irregular dust-proof and light-transmissive cover 7, ultimately forming interference patterns 42 and dynamic images 41 projected into space. Compared to the first embodiment, the ambient image projection device in this embodiment has a more compact structure, higher spatial utilization efficiency, and cost savings.

### Embodiment 3

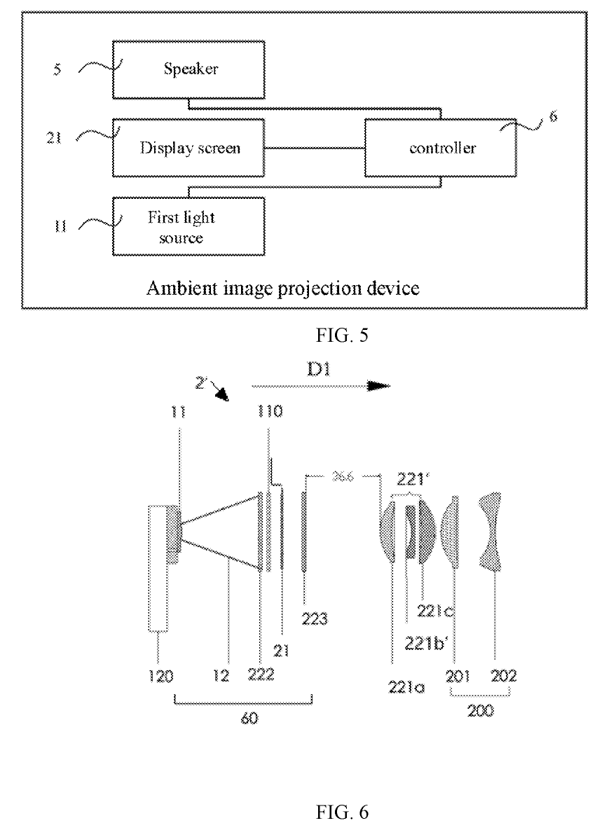

To provide users with an immersive experience, the inventors of the present disclosure have made optimized designs based on the aforementioned embodiments to further enhance projection effects of the ambient image projection device. As shown in FIG. 5, the ambient image projection device may include a speaker 5 and a controller 6. The controller 6 is in a communication connection with the display screen 21, the speaker 5, and the light source assembly 1, respectively. The controller 6 is configured to provide video signals to the display screen 21 and audio signals to the speaker 5. Additionally, the controller 6 adjusts parameters such as the intensity or frequency of the light emitted by the light source assembly 1 into the second projection mechanism 3 based on a waveform of the audio signals. This embodiment enables the light intensities of the interference pattern 42 and the dynamic image 41 to vary with the music through the controller 6, providing users with a dual sensory experience of sight and sound, which enhances an entertainment value. For instance, when the music is soft, the second light source 13 can dim accordingly; when the music is loud, the second light source 13 can brighten. When the music has a slow rhythm, the second light source 13 can flash at a lower frequency; when the music has a fast rhythm, the second light source 13 can flash at a higher frequency.

In one embodiment, as shown in FUG. 5, the controller 6 can further adjust the color of the light emitted by the light source assembly 1 into the second projection mechanism 3 based on RGB colors of the video signals. The display screen 21 displays a variety of colors, and by analyzing the predominant color, the controller 6 adjusts the color of the light emitted by the light source assembly 1 into the second projection mechanism 3. For example, if the predominant color displayed on the screen 21 is blue, the second light source 13 can be white, yellow, etc., to enhance contrast of the overall projection effect. It is understandable that a higher contrast results in clearer, more striking images with more vivid colors, which is beneficial for improving the user experience.

In this embodiment, the controller 6 can be a single-chip microcomputer integrated on the control circuit board of the light source assembly 1 or can be set up separately. The controller 6 can obtain control signals through a button switch or a wireless signal transceiver to control the intensity of the light in the second projection mechanism 3. Additionally, the control circuit board can rely on a DC power to supply electricity to the light source assembly 1.

### Embodiment 4

The present disclosure further provides an ambient image projection method, which includes:

Forming a dynamic image 41 from the content displayed on the display screen 21 under the guidance of the lens assembly 221 and projecting it into space;

Guiding the light emitted by the light source assembly 1 through the optical path module to form an interference pattern 42 by passing through the interference lens 31 and projecting it into space;

wherein the interference pattern 42 and the dynamic image 41 at least partially overlap in space.

The content displayed on the display screen 21 forms a dynamic image 41 to be projected into space, while the light emitted by the light source assembly 1 forms an interference pattern 42 by passing through the interference lens 31 and the interference pattern 42 is projected into space. Since the interference pattern 42 and the dynamic image 41 at least partially overlap in space, a more three-dimensional visual experience can be achieved. Compared to existing technologies, this embodiment projects images through the display screen 21 without the need for film, resulting in lower costs. Moreover, the display screen 21 can offer a wider variety of image choices with natural image transitions and convenient operation, significantly enhancing the user experience.

In the embodiment, the ambient image projection method may further include:

Providing video signals to the display screen 21 and audio signals to the speaker 5;

Adjusting the intensity or frequency of the light emitted by the light source assembly 1 into the optical path module based on the waveform of the audio signals;

Adjusting the color of the light emitted by the light source assembly 1 into the optical path module based on the RGB colors of the video signals.

The light intensities or flashing frequencies of the interference pattern 42 and the dynamic image 41 vary with the music, providing users with a dual sensory experience of sight and sound, and enhancing the entertainment value. This embodiment adjusts the color of the light emitted by the light source assembly 1 into the second projection mechanism 3 by analyzing the predominant color on the display screen 21, thereby improving the contrast between the foreground and background of the overall projection effect. It is understandable that a higher contrast results in clearer, more striking dynamic images 41 in the foreground with more vivid colors, providing a more impactful visual experience.

### Embodiment 5

Please refer to FIG. 6. Embodiment 5 of the present disclosure provides an ambient image projection device, which includes the first projection mechanism 2' similar with the first projection mechanism 2 from Embodiment 1 and a distortion lens assembly 200 positioned on a light-emitting side of the first projection mechanism 2'. The distortion lens assembly 200 is designed to receive the image light from the first projection mechanism 2', expand the projection range of the image light, and induce distortion in a portion of the image light at edge regions of the image light from the first projection mechanism 2', thereby generating a projected image with blurred edges.

In the ambient image projection device of this embodiment, after the imaging picture projected by the first projection mechanism 2' passes sequentially through the distortion lens assembly, the picture size can be enlarged while introducing curvilinear distortion at edge regions of the picture. Picture boundaries become blurred, with a sense of boundaries essentially disappearing, resulting in a more aesthetically pleasing and immersive viewing experience. This is particularly effective when displaying ambient scenes such as starry skies, enhancing the sense of immersion and user experience.

Specifically, the first projection mechanism 2' and the distortion lens assembly 200 can be coaxially arranged. In one embodiment, the distortion lens assembly 200 includes a third convex lens 201 and a second concave lens 202. The third convex lens 201 is arranged adjacent to the first projection mechanism 2', while the second concave lens 202 is arranged on a side of the third convex lens 201 opposite to the first projection mechanism 2'.

More specifically, the third convex lens 201 is a plano-convex lens, meaning a first side facing the first projection mechanism 2' is convex, and a second side opposite to the first side is flat. The second concave lens 202 is a biconcave lens, with both sides being concave. It is understandable that a combination of the third convex lens 201 and the second concave lens 202 can achieve favorable edge distortion imaging effects, particularly suitable for displaying ambient scenes such as night skies, starry skies, the universe, and galaxies.

Furthermore, in this embodiment, a concave curvature on the light-receiving side of the second concave lens 202 is greater than that on the light-emitting side. Additionally, a diameter of a projected pattern along an optical axis of the second concave lens 202 on the light-receiving side is smaller than that on the light-emitting side.

A maximum thickness of the third convex lens 201 ranges from 6.2 mm to 10.2 mm. A distance between a center of the concave surface of the second concave lens 202 facing the third convex lens 201 and an optical center of the third convex lens 201 ranges from 11.7 mm to 21.7 mm. It is understandable that by setting these parameter ranges, favorable projection imaging effects can be achieved.

In this embodiment, a total thickness of the third convex lens 201 is 8.2 mm, a diameter of a convex surface of the third convex lens 201 is 30 mm. A distance between the optical center of the third convex lens 201 and a center of its convex surface is 7.5 mm. For the second concave lens 202, a diameter of the concave surface facing the third convex lens 201 is 26 mm and a depth of the concave surface facing the third convex lens 201 is 5.3 mm, while a diameter of a concave surface opposite to the third convex lens 201 is 35 mm and a depth of the concave surface opposite to the third convex lens 201 is 2.6 mm. The distance between the centers of the two concave surfaces of the second concave lens 202 is 2.5 mm. The distance between the center of the concave surface of the second concave lens 202 facing the third convex lens 201 and the optical center of the third convex lens 201 is 16.7 mm.

More specifically, a total thickness of the second concave lens 202 is 10.4 mm. It should be noted that the total thickness of the second concave lens 202 can range from 8.4 mm to 12.4 mm.

Similar to the previous embodiments 1-4, the first projection mechanism 2' includes a projection assembly 60 that is the same with the projection assembly 60 in the embodiments 1-4 and a lens assembly 221' similar to the lens assembly 221 in the embodiments 1-4. The lens assembly 221' of the first projection mechanism 2' includes a first convex lens 221a, a first concave lens 221b', and a second convex lens 221c (also known as a fisheye lens). The convex surface of the first convex lens 221a faces the first light source 11, the concave surface of the first concave lens 221b' faces the flat surface of the first convex lens 221a, and the convex surface of the second convex lens 221c faces the convex surface of the third convex lens 201 in the distortion lens assembly 200. The difference between the first concave lens 221b' in the embodiment and the first concave 221b in above embodiments 1-4 is that the first concave lens 221b' is a plane-concave lens, with its concave surface positioned adjacent to the first convex lens 221a.

In the aforementioned lens group configuration, the imaging picture projected by the projection assembly 60 passes sequentially through the third convex lens 201 and the second concave lens 202 of the distortion lens assembly 200. This allows for the enlargement of the picture size while introducing curvilinear distortion at the picture edges. The distorted picture boundaries become blurred, with the sense of boundary essentially disappearing, creating a starry or night sky effect in dark environments. Ultimately, this achieves a visual effect where the image boundaries are blurred without compromising the clarity of the central image.

### Embodiment 6

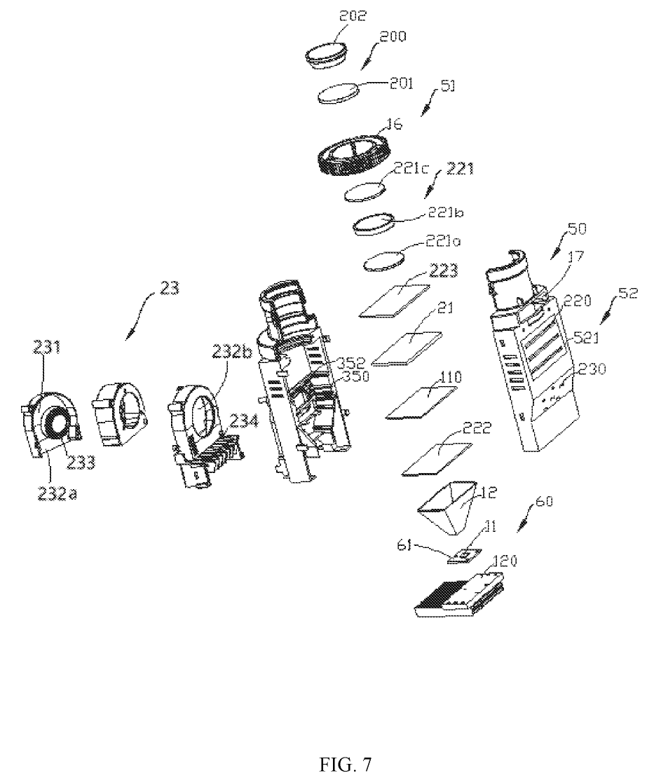

Please refer to FIG. 7. Embodiment 6 of the present disclosure provides an ambient image projection device. In addition to including all the components of Embodiment 5 (the first projection mechanism 2' and the distortion lens assembly 200), the ambient image projection device may further include other components such as an optical engine housing 50.

Specifically, the first projection mechanism 2' includes the first light source 11, the light-concentrating element 12, the first lens 222, the display screen 21, the second lens 223, the lens assembly 221' (which includes the first convex lens 221a, a first concave lens 221b', and the second convex lens 221c), and the distortion lens assembly 200 coaxially arranged in sequence along the light-emitting direction,.

The lens assembly 221' is positioned between the distortion lens assembly 200 and the light source assembly 60 (which includes the first light source 11, the light-concentrating element 12, the first lens 222, the display screen 21, and the second lens 223). The lens assembly 221' faces the second lens 223. The first light source 11 is placed at one end of the light-concentrating element 12, while the first lens 222 is situated at the other end of the light-concentrating element 12. The first lens 222 and the second lens 223 are positioned on opposite sides of the display screen 21. The lens assembly 221 can also be referred to as a projection lens module. In this embodiment, it includes the first convex lens 221a, the first concave lens 221b', and the second convex lens 221c. However, in other embodiments, the number of lenses can be adjusted as needed.

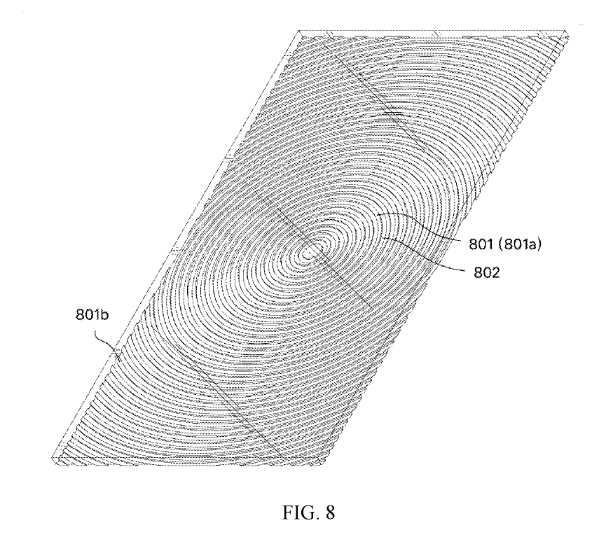

Specifically, both the first lens 222 and the second lens 223 are Fresnel lenses. As shown in FIG. 8, a Fresnel lens includes a central point and multiple concentric annular protrusions 801 arranged sequentially around it. Between each pair of adjacent annular protrusions 801, an annular groove 802 is formed. It is understandable that a width of the annular protrusions 801 falls within a certain range. The Fresnel lens has a rectangular shape, and the annular protrusions in the central region are complete circular protrusions 801a, while some of the annular protrusions in the peripheral region are divided into two opposing arc-shaped protrusions 801b.

Furthermore, in this embodiment, a heat-insulating glass 110 is placed between the first lens 222 and the display screen 21. It is understandable that the heat-insulating glass 110 can isolate or reduce heat transfer between the display screen 21 and the first light source 11, which is beneficial for improving a service life and an imaging effect of the ambient image projection device. However, in other embodiments, the heat-insulating glass 110 may be omitted.

Additionally, in this embodiment, the distance between the center of the convex surface of the first convex lens 221a in the lens assembly 221' and the surface of the second lens 223 facing the lens assembly 221' ranges from 23 mm to 36.6 mm; specifically, it can be 36.6 mm. It is understandable that by setting the distance between the center of the convex surface of the first convex lens 221a and the surface of the second lens 223 facing the lens assembly 221' within a predetermined range, imaging quality can be ensured, enhancing the user experience.

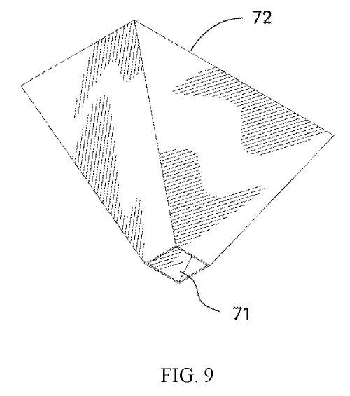

As shown in FIG. 9, the light-concentrating element 12 has a conical structure with a gradually increasing diameter along the optical path direction D1. The light-concentrating element 12 includes a light inlet 71 and a light outlet 72. A size of a light-emitting area of the first light source 11 is adapted to and corresponds with a size of the light inlet 71, ensuring that substantially all the light emitted by the first light source 11 enters the light-concentrating element 12 through the light inlet 71, thereby improving light utilization efficiency.

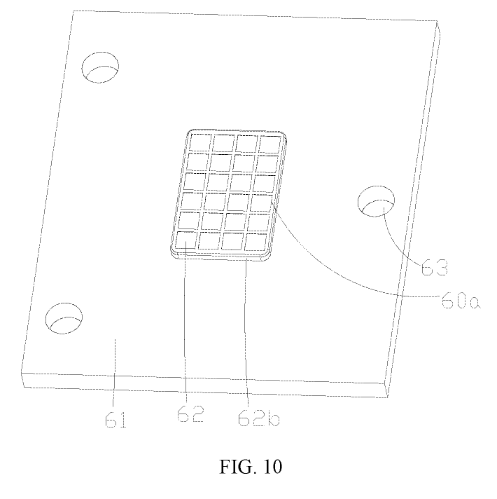

As shown in FIG. 10, the first light source 11 includes a fixed plate 61, a substrate 60b, and a plurality of light-emitting elements 62 arranged on the substrate 60b. The plurality of light-emitting elements 62 enclose a light-emitting area 60a. In this embodiment, a size of the substrate 60b is substantially equal to that of the light-emitting area 60a. The substrate 60b can be positioned inside the light inlet 71 so that the plurality of light-emitting elements 62 are located within the light-concentrating element 12. In this embodiment, the plurality of light-emitting elements 62 are arranged in a matrix pattern, such as a 4x6 matrix. The fixed plate 61 defines multiple first fixing holes 63 for securing it to other components (e.g., the heat-dissipation member 120). These multiple fixing holes 63 are arranged in a triangular pattern to achieve a more stable fixing effect. In some other embodiments, the size, length, and width of the matrix formed by the plurality of light-emitting elements 62 can be adjusted according to actual needs, such as a 3x5 matrix or a 6x6 matrix. The planar size of the substrate 60b can be larger than that of the light-emitting area 60a formed by arrangement of the plurality of light-emitting elements 62. The shape of the substrate 60b is not limited to a square, a rectangular, a circular, or elliptical shapes. Generally, the shape of the substrate 60b can be consistent with that of the light inlet 71 of the light-concentrating element, such as both being rectangular, which is beneficial for improving light utilization efficiency.

It can be understood that through the aforementioned ambient image projection device, the light emitted by the first light source 11 sequentially passes through the light-concentrating element, the first lens 222, the display screen 21, the second lens 223, the lens assembly 221', and the distortion lens assembly 200 before being projected onto a carrier, resulting in an imaged picture.

In this embodiment, the first light source 11 is further connected to a heat-dissipation member 120 for dissipating heat from the first light source 11. Specifically, the heat-dissipation member 120 can be connected to the side of the first light source 11 opposite to the light-concentrating element 12, thereby dissipating heat from the first light source 11 to the periphery away from the projection assembly, thus avoiding issues such as excessive heat affecting the imaging effect and service life of the ambient image projection device.

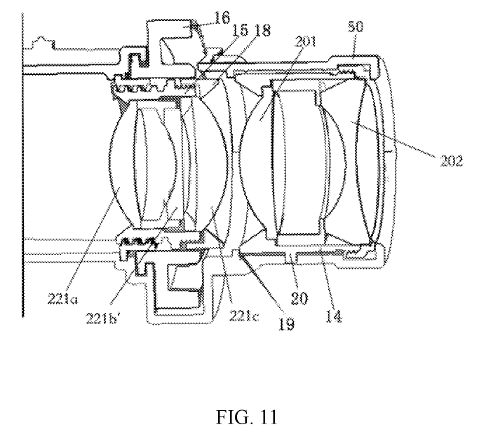

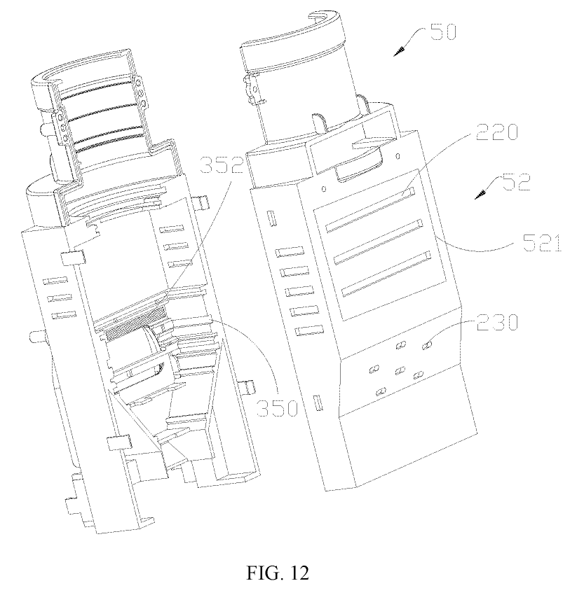

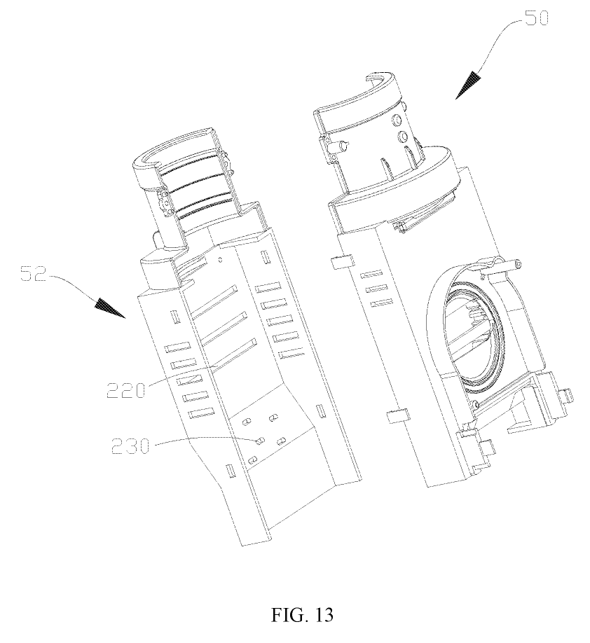

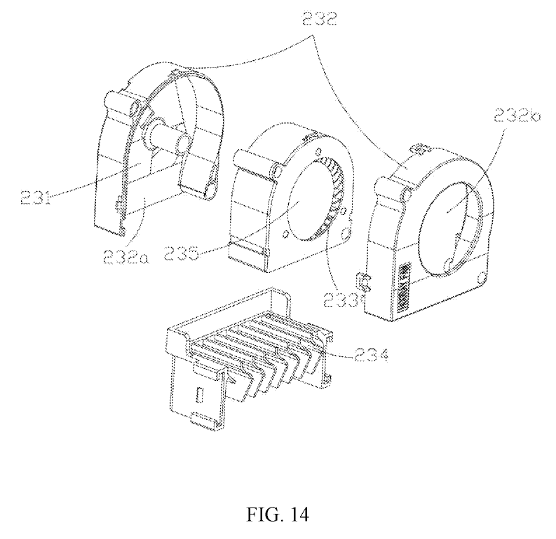

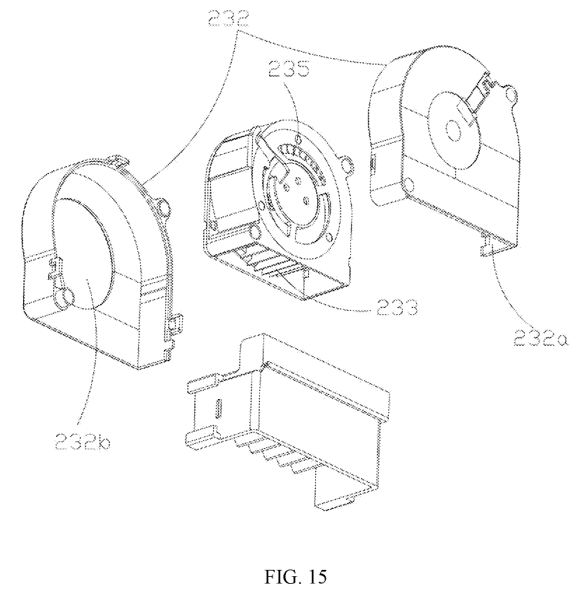

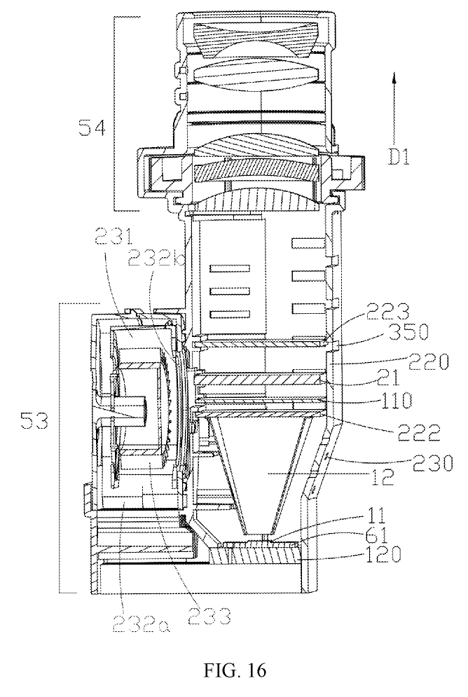

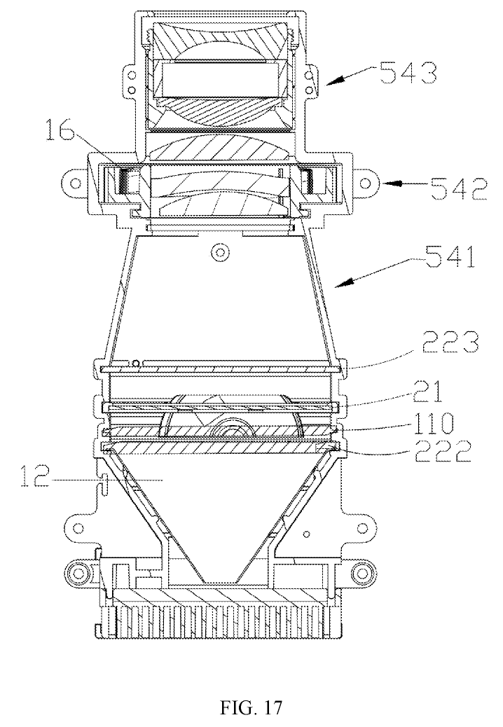

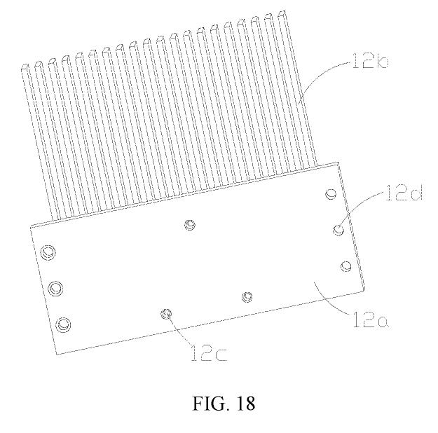

Furthermore, as shown in FIGS. 11-18, the ambient image projection device further includes an optical engine housing 50. The projection assembly 60, the lens assembly 221', and distortion lens assembly 200 are all arranged inside the optical engine housing 50. The optical engine housing 50 includes at least one air inlet 52. The ambient image projection device further includes a first cooling fan 23 located on the side of the projection assembly 60 that is opposite to the at least one air inlet 52, which allows air from the at least one air inlet 52 to be provided to the first cooling fan 23 through gaps between adjacent components of the projection assembly 60, thereby carrying heat away from the projection assembly 60. It can be understood that by placing the first cooling fan on the side away from the at least one air inlet 52, a cooling channel can be formed to dissipate heat from the projection assembly 60, reducing the overall temperature of the ambient image projection device.

The at least one air inlet 52 includes at least one first air inlet 220 and at least one second air inlet 230. The at least one first air inlet 220 corresponds to the position between the insulating glass 110 and the second lens 223, while the at least one second air inlet 230 corresponds to the position of the light-concentrating element 12. Specifically, the at least one second air inlet 230 includes several air intake through-holes. It can be understood that the design of multiple air inlets is beneficial for improving the heat dissipation effect.

By placing the at least one second air inlet 230 on the top of the optical engine housing 50, air enters through the several air intake through-holes of the at least one second air inlet 230 from above, circulates around the light-concentrating element 12, and then enters the first cooling fan 23 from a lower side of the light-concentrating element 12. The hot air is ultimately drawn away by the first cooling fan 23 located below, which can significantly carry away heat from the light-concentrating element 12 and the first light source 11, thereby greatly improving the cooling effect.

The optical engine housing 50 can include a first part 53 and a second part 54 connected sequentially along the optical path direction. The projection assembly 60 is arranged in the first part 53, while the lens assembly 221' and the distortion lens assembly 200 are placed in the second part 54. It can be understood that by using an integrated optical engine housing 50 to align and install the projection assembly 60, the lens assembly 221', and the distortion lens assembly 200 together, it can ensure the structural strength of the ambient image projection device and further guarantee the alignment effect, thereby achieving a better imaging effect.

The first part 53 has multiple first mounting slots 350. Each of the first lens 222, the display screen 21, and the second lens 223 corresponds to and installed in one of these first mounting slots. The first mounting slots 350 can be sliding slots. The first part 53 is divided into an upper housing and a lower housing that are connected to each other. The first mounting slots 350 is arranged on the lower housing. When the upper housing is separated from the lower housing, the first lens 222, the display screen 21, and the second lens 223 can be slidably installed on or removed from the lower housing corresponding to the first mounting slots 350. It can be understood that arrangement of the first mounting slots 350 can fix the first lens 222, the display screen 21, and the second lens 223 in predetermined positions, facilitating assembly of each component while ensuring heat dissipation and imaging effects.

In this embodiment, the first mounting slot 350 adjacent to the first cooling fan 23 is further provided with dust-proof oil 352, which can adsorb dust and impurities, avoiding any impact on imaging.

As previously mentioned, the light-concentrating element 12 is conical with a gradually increasing diameter along the optical path direction D1. The shape of the part of the first part 53 where the light-concentrating element 12 is arranged is adapted to the light-concentrating element 12, ensuring not only their assembly but also making the design of the ambient image projection device more compact, which is beneficial for miniaturization and lightweighting.

In this embodiment, the display screen 21 is substantially rectangular. Therefore, a cross-section of the light-concentrating element 12 perpendicular to the optical path direction D1 can be rectangular. That is, the shape of the display screen 21 is adapted to and comparable in size to the cross-sectional shape of the light-concentrating element 12 perpendicular to the optical path direction D1, which can also contribute to improving the light utilization efficiency of the projection assembly 60.

Furthermore, the distortion lens assembly 200 and the optical engine housing 50 are equipped with alignment and mating structures to facilitate their assembly. Specifically, the alignment and mating structures include, but are not limited to, alignment protrusions, grooves, labels, etc.

The at least one air inlet 52 is further provided with a dust-proof air intake membrane 521 to prevent dust and other debris from entering the interior of the ambient image projection device and affecting the imaging quality. The dust-proof air intake membrane 521 can be a non-woven fabric with multiple irregular air intake gaps, adhered to the optical engine housing 50 using a colloid. It has advantages of low weight and good dust-proof air intake performance, but the specific material is not limited to the above.

In the ambient image projection device of this embodiment, the air outlet direction of the first cooling fan 23 is oriented towards the heat-dissipation member 120, so that it can blow air towards the heat-dissipation member 120 to carry away its heat, further improving the cooling effect.

Specifically, the heat-dissipation member 120 includes a heat dissipation substrate 12a that fixes the first light source 11 and multiple cooling fins 12b connected to the side of the heat dissipation substrate 12a that is away from the first light source 11. The multiple cooling fins 12b are spaced apart and extend to the air outlet of the first cooling fan 23, allowing the first cooling fan 23 to blow air into the gaps among the multiple cooling fins 12 to carry away the heat from the heat-dissipation member 120. The heat-dissipation member 120 may further include a second fixing hole 12c and a third fixing hole 12d. The second fixing hole 12c can be configured to fix the first light source 11, while the third fixing hole 12d can be configured to fix the heat-dissipation member 120 onto the optical engine housing 50.

The first cooling fan 23 includes a fan housing 232 with an installation cavity 231 and fan blades 233 located within the installation cavity 231. The fan blades 233 can be turbine blades, and the direction of their fan shaft can be perpendicular to the optical path direction D1, allowing the fan blades 233 to guide the heat from the projection assembly 60 at the top towards the side where the first light source 11 is located.

In this embodiment, the fan housing 232 further has a fan air inlet 232a facing the projection assembly 60 and a fan air outlet 232b. At the fan air outlet 232b, there are multiple air guide vanes 234. The air blown between the multiple air guide vanes 234 is directed towards the heat-dissipation member 120 in parallel, which can more uniformly and effectively carry away the heat from the first light source 11 on the heat-dissipation member 120.

Additionally, the fan housing 232 can be snap-fitted onto the optical engine housing 50, facilitating the assembly and disassembly of the first cooling fan 23.

In this embodiment, the ambient image projection device may further include at least one lens barrel. The lens assembly 221' can be installed within the at least one lens barrel and can move back and forth along the optical path direction D1 with the at least one lens barrel to adjust a projection focal length. However, it is necessary to ensure that there is always a distance between the distortion lens assembly 200 and the lens assembly 221' to ensure imaging.

Specifically, the at least one lens barrel may include a fixed base member 14 and a movable lens barrel 15. The fixed base member 14 is positioned in front of the movable lens barrel 15. The distortion lens assembly 200 is fixedly installed within the fixed base member 14, while the lens assembly 221' is fixedly installed within the movable lens barrel 15. The movable lens barrel 15 can drive the lens assembly 221' to move back and forth to adjust the projection focal length. The back-and-forth movement of the at least one lens barrel along the optical path direction D1 can be automatically or manually adjusted.

In this embodiment, a focusing wheel 16 is sleeved on an exterior of the movable lens barrel 15, and the movement of the focusing wheel 16 can drive the movable lens barrel 15 to move back and forth. Specifically, the outer surface of the movable lens barrel 15 may be provided with external threads, while the inner surface of the focusing wheel 16 is provided with internal threads that match the external threads, which allows rotation of the focusing wheel 16 to drive the movable lens barrel 15 to bring the lens assembly 221' to move back and forth along the optical path direction D1 for focusing.

The front end of the optical engine housing 50 is provided with two focusing wheel protruding holes 17 configured to allow both sides of the focusing wheel 16 protrude therethrough to an exterior of the optical engine housing 50 respectively. With the aforementioned structure, when the focusing wheel 16 is turned, since it is restricted by the focusing wheel protruding holes 17 and cannot move back and forth, the movable lens barrel 15 is driven to move back and forth, which can then bring the lens assembly 221' to move back and forth to adjust the focal length.

Furthermore, in the optical engine housing 50, the second part 54 includes a first section 541, a second section 542, and a third section 543 connected sequentially along the optical path direction D1. The diameter of the first section 541 gradually decreases along the optical path direction D1. The diameter of the second section 542 is larger than that of the first section 541 and the third section 543, and the second section 542 has the focusing wheel protrusion holes 17 for exposing the focusing wheel 16. The lens assembly 221' is positioned on the focusing wheel 16. Such three-section arrangement of the second part 54 not only matches the optical path of the ambient image projection device to ensure imaging but also contributes to the compactness of the overall design of the ambient image projection device, reducing size and weight of the ambient image projection device. Furthermore, through the focusing wheel 16 and the focusing wheel protrusion hole 17, manual or automatic focusing is also facilitated to ensure imaging effects.

More specifically, in this embodiment, the front end of the focusing wheel 16 is provided with a limiting structure 18. When the movable lens barrel 15 moves to the position of the limiting structure 18, the front end of the movable lens barrel 15 resists against the limiting structure 18, and at this time, there is still a distance between the lens assembly 221' and the distortion lens assembly 200, ensuring imaging.

In this embodiment, an engagement groove 19 that matches the fixed base member 14 is provided inside the front end of the optical engine housing 50, and the fixed base member 14 can be precisely positioned, engaged, and fixed within the engagement groove 19.

Furthermore, in this embodiment, a positioning post 20 is provided on the outer surface of the fixed base member 14, and a corresponding positioning hole is provided on the front end of the optical engine housing 50. The positioning post 20 is configured to be inserted into the positioning hole.

Through the above-mentioned structures of the engagement groove 19, the positioning post 20, and the positioning hole, the fixed base member 14 along with the distortion lens assembly 200 can be well fixed at the front end of the optical engine housing 50, preventing changes in the distortion effect caused by the movement of the distortion lens assembly 200.

### Embodiment 7

The structure of this embodiment is substantially the same as that of Embodiment 6. In other words, the description provided for Embodiment 6 of the present disclosure can generally be applied to Embodiment 7. The following mainly describes the differences between Embodiment 7 and Embodiment 6.

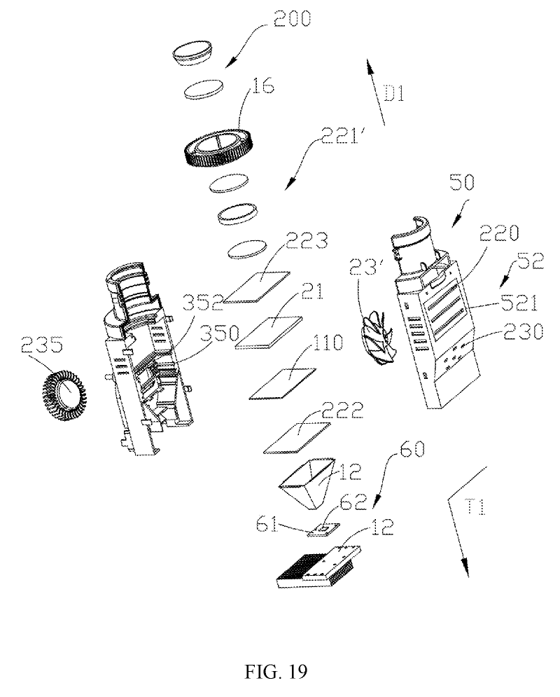

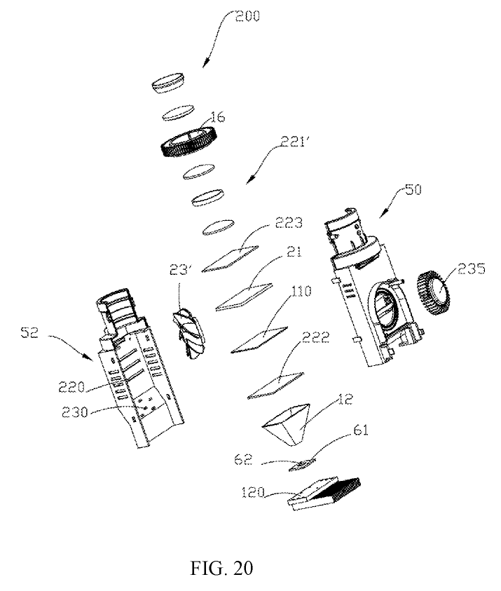

In the seventh embodiment, as shown in FIGS. 19 and 20, the ambient image projection device may further include a second heat-dissipation fan 23'. The second heat-dissipation fan 23' can be installed at the least one air inlet 52. The second heat-dissipation fan 23' is used to blow air from the at least one air inlet 52 towards the projection assembly 60. It can be understood that the second heat-dissipation fan 23' can be located inside the optical engine housing 50 and can be an axial fan. It is configured to draw air from the at least one air inlet 52 at the top of the optical engine housing 50 into the housing 50, and then blow the air through the gaps between two adjacent components of the projection assembly 60 along the optical path direction D1 towards the first cooling fan 23'. In this embodiment, the first cooling fan 23 and the second heat-dissipation fan 23' are respectively installed on opposite sides of the optical engine housing 50. Specifically, the second heat-dissipation fan 23' is adjacent to the air inlet 52 at the top of the optical engine housing 50, and the second heat-dissipation fan 23' is installed adjacent to the bottom of the optical engine housing 50 and directs the air from the projection assembly 60 above towards the rear end of the ambient image projection device, thus forming a heat-dissipation path T1 from top to bottom and then to the rear side. It can be understood that using two heat-dissipation fans 23 and 23' to dissipate heat from the projection assembly can improve heat-dissipation efficiency and imaging effects, as well as extend the service life of the ambient image projection device.

### Embodiment 8

The structure of this embodiment is basically the same as that of Embodiment 6. That is to say, the description of Embodiment 6 in the present disclosure can generally apply to Embodiment 8. The following mainly describes the differences between them.

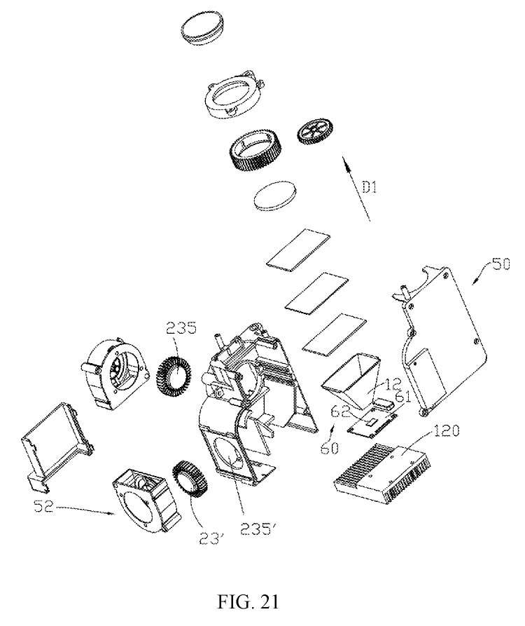

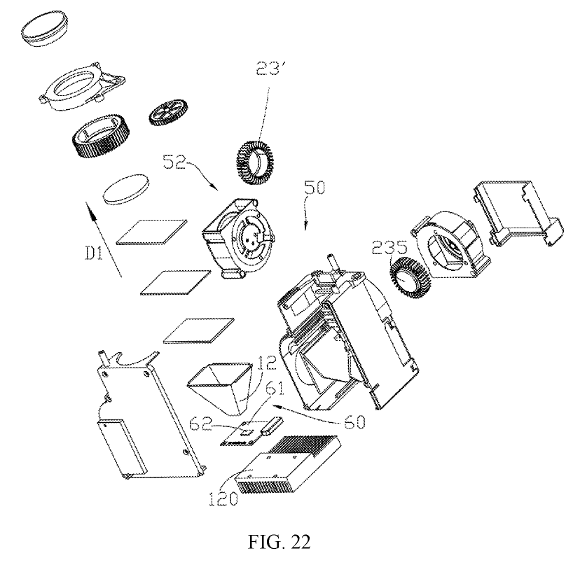

In the eighth embodiment, as shown in FIGS. 21 and 22, the ambient image projection device may further include a second heat-dissipation fan 23'. The air inlet 52 of the ambient image projection device is arranged on a side of the optical engine housing 50. An air duct 235' for accommodating the second heat-dissipation fan 23’ is further formed inside the optical engine housing 50. The outlet of the air duct 235' faces the gaps between two adjacent components in the projection assembly 60, so that the second heat-dissipation fan 23' is used to blow air from the at least one air inlet 52 towards the projection assembly 60.

It can be understood that in this embodiment, the second heat-dissipation fan 23' can be a turbo fan. The axial direction of the second heat-dissipation fan 23' can be perpendicular to that of the first cooling fan 23. The second heat-dissipation fan 23' is used to draw air from at least one air inlet 52 on the side of the optical engine housing 50 into the optical engine housing 50, and then blow the air through the gaps between two adjacent components along the optical path direction D1 of the projection assembly 60 towards the first cooling fan 23.

In this embodiment, the first cooling fan 23 and the second heat-dissipation fan 23' are respectively installed on two adjacent sides of the optical engine housing 50. Specifically, the second heat-dissipation fan 23' is adjacent to the air inlet 52 on the side of the optical engine housing 50, and the first cooling fan 2123 is installed adjacent to the bottom of the optical engine housing 50 and directs the air from the projection assembly 60 above towards the rear end of the ambient image projection device, thus forming a heat-dissipation channel from the side to the bottom and then to the rear side. It can be understood that using two heat-dissipation fans 23 and 23' to dissipate heat from the projection assembly can improve heat-dissipation efficiency and imaging effects, as well as extend the service life of the ambient image projection device.

### Embodiment 9

The structure of this embodiment is basically the same as that of Embodiment 6. That is to say, the description of Embodiment 6 in the present disclosure can generally apply to Embodiment 9. The following mainly describes the differences between the two embodiments.

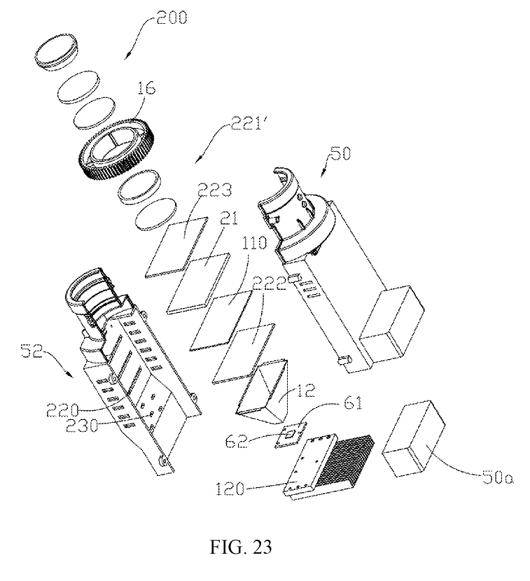

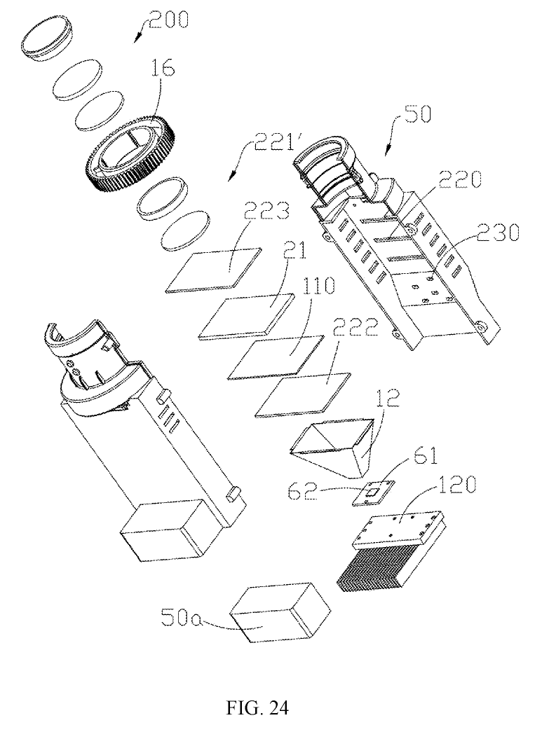

As shown in FIGS. 23 and 24, the ambient image projection device in the nineth embodiment omits the cooling fan compared to that in the sixth embodiment, eliminating the need for air vents on a bottom plate of a lower portion of the optical engine housing 50. Specifically, the lower portion of the optical engine housing 50 is integrally formed with a protruding heat-dissipation member accommodation section 50a, within which the heat-dissipation member 120 is installed. It is understandable that this arrangement can result in a lighter and smaller ambient image projection device, facilitating portability.

### Embodiment 10

The structure of this embodiment is substantially the same as that of Embodiment 6. In other words, the description provided for Embodiment 6 of the present disclosure can generally be applied to Embodiment 10. The following mainly describes the differences between the two embodiments.

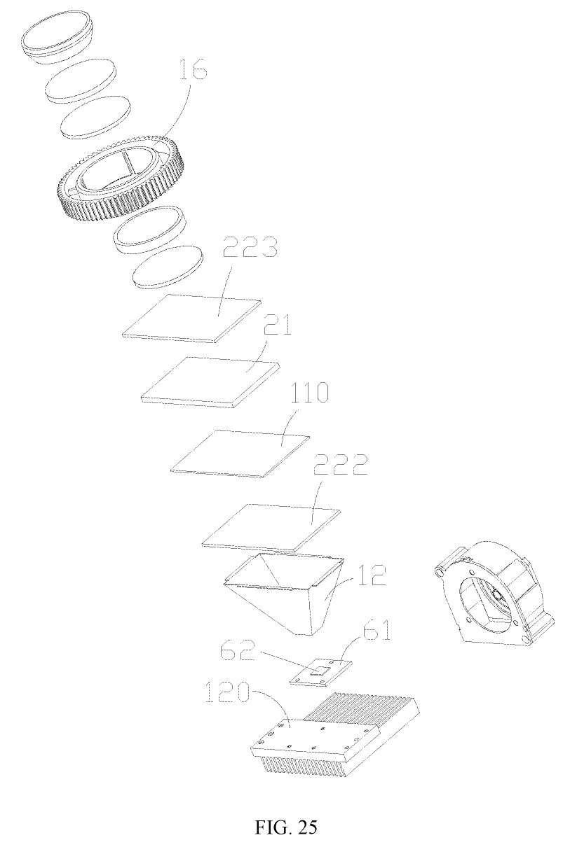

As shown in FIG. 25, the ambient image projection device in the tenth embodiment omits the optical engine housing compared to that in the sixth embodiment. This means that the components inside the optical engine housing of sixth embodiment can be placed on a housing of a terminal product that uses the ambient image projection device. In other words, the housing of the terminal product integrates the functions of the optical engine housing, achieving a compact and lightweight design for the terminal product.

### Embodiment 11

The structure of this embodiment is substantially the same as that of Embodiment 6. In other words, the description provided for Embodiment 6 of the present disclosure can generally be applied to Embodiment 11. The following mainly describes the differences between the two embodiments.

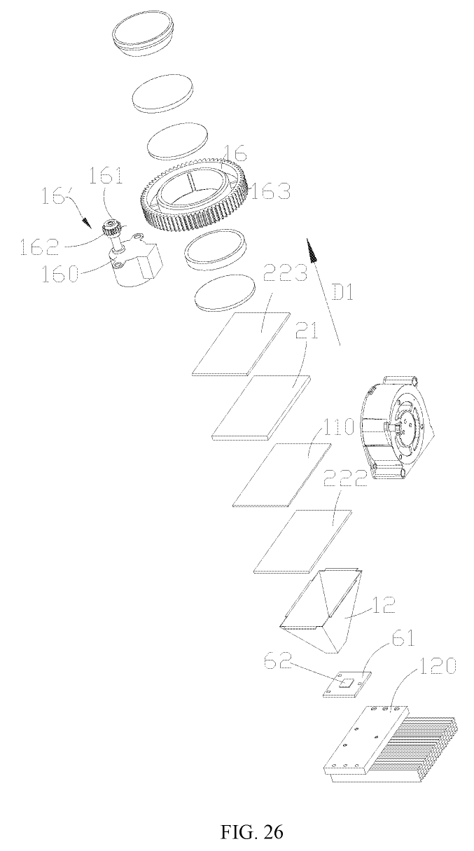

As shown in FIG. 26, the ambient image projection device in Embodiment 11 includes an additional drive device 16' compared to that in Embodiment 6. The drive device 16' is configured to drive the at least one lens barrel to move back and forth along the optical path direction D1 for projection focal length adjustment. Specifically, the drive device 16' can drive the focusing wheel 16 to move the movable lens barrel 15 along the optical path direction D1.

The drive device 16' may include a motor 160. An axial direction of an output shaft 161 of the motor 160 may be the same as the optical path direction D1. The output shaft 161 is equipped with a first meshing structure 162, and the outer surface of the focusing wheel 16 is equipped with a second meshing structure 163. The first meshing structure 162 and the second meshing structure 163 mesh with each other, so that when the output shaft 161 of the motor 160 rotates, the first meshing structure 162 rotates, driving the second meshing structure 163 to rotate as well. Consequently, the focusing wheel 16 rotates and drives the movable lens barrel 15, which is threadedly connected to the focusing wheel 16, to move along the optical path direction D1 for focusing.

### Embodiment 12

The structure of this embodiment is substantially the same as that of Embodiment 6. In other words, the description provided for Embodiment 6 of the present disclosure can generally be applied to Embodiment 12. The following mainly describes the differences between the two embodiments.

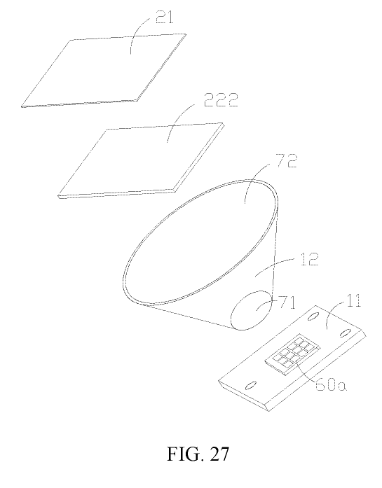

In this embodiment, as shown in FIG. 27, the light inlet 71, the light outlet 72, and the cross-section of the light-concentrating element 12 are all circular. The light-emitting area 60a of the first light source 11 can be circular and sized to match the light inlet 71.

Correspondingly, the first lens 222 (or the second lens 223) at the light outlet 72 and the display screen 21 can be circular, allowing for shape compatibility among the components to achieve high light utilization efficiency and compact structural design. However, it is understandable that in some modified embodiments, the shapes of the cross-section of the light-concentrating element 12, the light-emitting area 60a of the first light source 11, the first lens 222 (or the second lens 223) at the light outlet 72, and the display screen 21 may vary. Slightly lower light utilization efficiency or slightly larger product dimensions due to shape incompatibility will not affect the basic projection and imaging performance of the ambient image projection device.

### Embodiment 13

The structure of Embodiment 13 is substantially the same as that of Embodiment 6. In other words, the description provided for Embodiment 6 of the present disclosure can generally be applied to Embodiment 13. The following mainly describes the differences between the two embodiments.

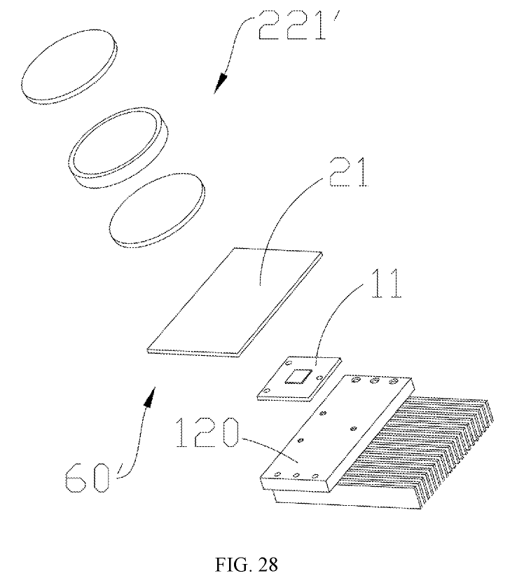

As shown in FIG. 28, the projection assembly 60' of the ambient image projection device in Embodiment 13 omits the light-concentrating element, the first lens, and the second lens compared to that in Embodiment 6. This means that the light emitted from the first light source 11 can be directly projected onto the display screen 21, which then projects the image through the lens assembly 221'.

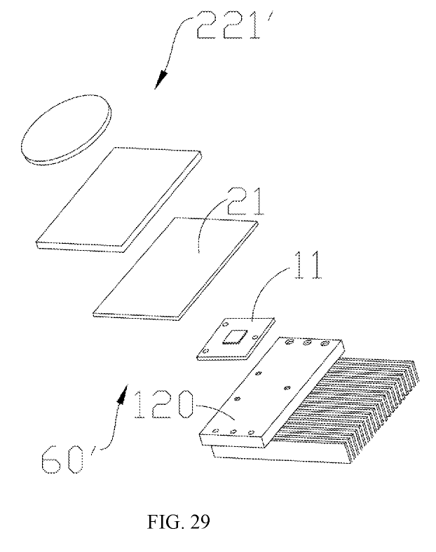

Additionally, in some modified embodiments, as shown in FIG. 29, the number of lenses in the lens assembly 221'' can be reduced to just one convex lens, as long as it can fulfill the projection function.

Omitting the light-concentrating element, the first lens, the second lens, and some lenses in the lens assembly 221 can reduce the product weight, facilitating portability.

Furthermore, in the embodiments shown in FIGS. 28 and 29, the light emitted from the first light source 11 can be controlled within a preset angle, ensuring that substantially all of the light emitted from the first light source 11 is provided to the display screen 21 after passing through a preset transmission space, thereby guaranteeing the light utilization efficiency of the projection assembly 60'.

### Embodiment 14

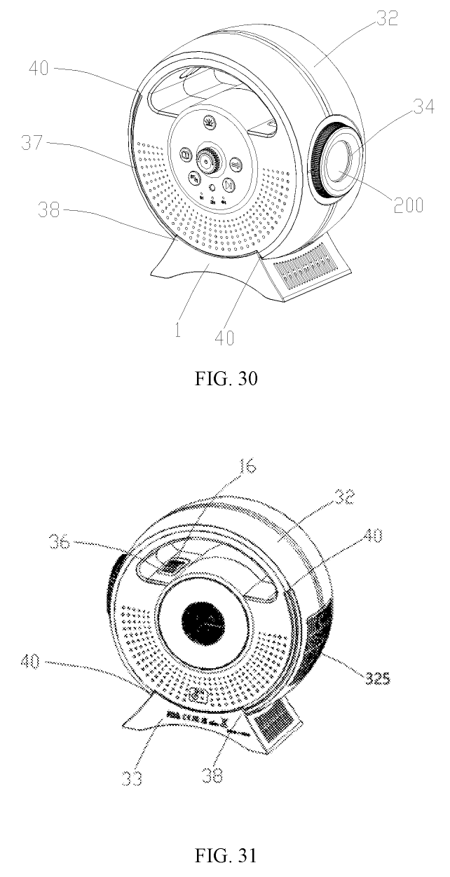

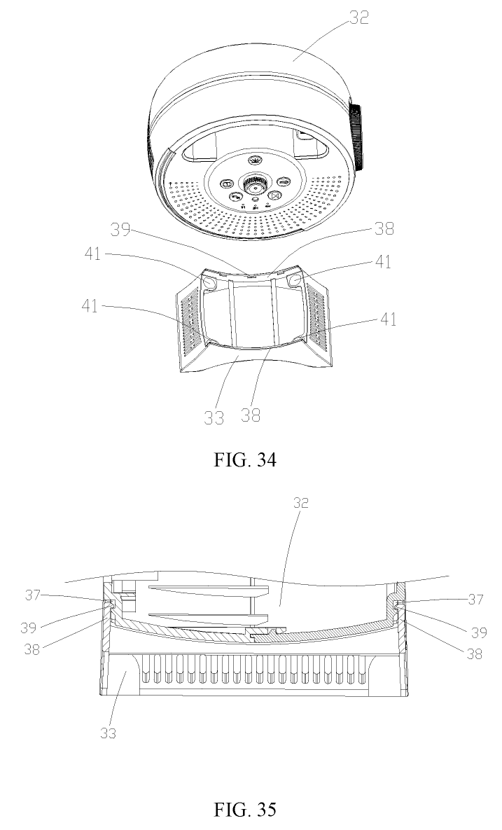

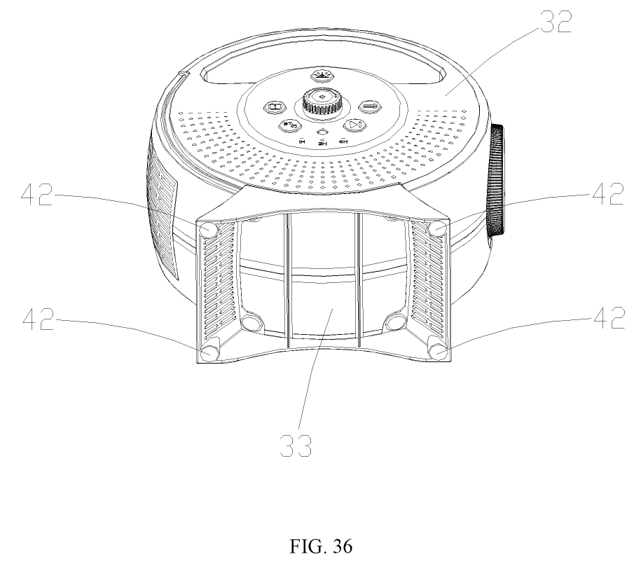

As shown in FIGS. 30 to 38, in addition to all the components of any one of Embodiments 5 to 13, the ambient image projection device in this embodiment further includes an outer housing.

Specifically, the outer housing may include a main housing 32 and a base 33. The main housing 32 is movably mounted on the base 33 to facilitate adjustment of the projection angle of the ambient image projection device. The optical engine housing 50 can be placed inside the main housing 32, which is equipped with a projection aperture 34 corresponding to the distorted lens assembly 200.

Specifically, the front end of the optical engine housing 50 can be inserted into the projection aperture 34, while the rear end of the optical engine housing 50 is placed into a first receiving groove 320 on the inner wall of the main housing 32, enabling simple and convenient assembly of the ambient image projection device. Additionally, the main housing 32 is equipped with a focusing aperture 36 through which the focusing wheel 16 protrudes, facilitating easy operation.

The main housing 32 can be assembled by joining a left housing 323 and a right housing 322. A front cover 323 with the projection aperture 34 is provided at the front end, while a rear cover 324 is provided at the rear end. The rear cover 324 is integrated with the main housing 32, and the first receiving groove 322 is arranged on the rear cover 324 for securing rear-end components (such as the heat-dissipation member 120) of the ambient image projection device. Multiple heat dissipation holes 325 are provided on the bottom plate of the first receiving groove 320 for heat-dissipation member 120 heat dissipation.

Furthermore, the sides of the main housing 32 are provided with first sliding structures (e.g., sliding grooves 37). Correspondingly, sidewalls 38 extend from both sides of the base 33, with second sliding structures (e.g., sliding blocks 39) extending inwardly from the sidewalls 38. The first and second sliding structures cooperate (e.g., sliding blocks 39 are inserted into sliding grooves 37), enabling the main housing 32 to slide relative to the base 33 and adjust the position of the preset ambient imaging scene of the ambient image projection device.

During use, the main housing 32 slides relative to the base 33 via the cooperation of the sliding grooves 37 and sliding blocks 39. This sliding structure ensures a stable and reliable relative movement between the main housing 32 and the base 33. Additionally, the main housing 32 is directly connected to the base 33 without the need for additional connectors, simplifying the structure, reducing the risk of structural failures, and lowering production costs.

Furthermore, the main housing 32 is circular, with the first sliding structures (e.g., sliding grooves 37) arranged along the edges of the top and bottom surfaces, forming an arc-shaped structure (e.g., arc-shaped sliding grooves). Correspondingly, the second sliding structures include arc-shaped sliding blocks 39 on the sidewalls 38 of the base 33. Multiple sliding blocks 39 can be provided on each sidewall 38. During use, the main housing 32 can rotate relative to the base 33, which is more convenient in operation. Additionally, stoppers 40 are provided at both ends of the sliding grooves 37 to limit the rotation travel of the main housing 32.

Furthermore, the base 33 is equipped with damping pads 41 that conform to the bottom of the main housing. Multiple damping pads can be provided. The damping pads 41 enhance the adhesion between the main housing 32 and the base 33. When the main housing 32 rotates, the damping pads 41 provide flexible friction, ensuring a smooth rotation without noticeable friction sounds and providing a comfortable user experience. Additionally, they prevent wear and tear on components due to rigid contact between the main housing 32 and the base 33, extending the lifespan of the ambient image projection device. Combined with the aforementioned structure, the weight of the main housing 32 ensures continuous contact with the damping pads 41, preventing loss of function of the damping pads due to wear. Moreover, when the built-in speaker of the ambient image projection device operates, the damping pads 41 absorb vibrations, ensuring stable projection without shaking or movement, effectively enhancing the user experience. They also reduce the risk of product resonance, preventing abnormal noises or structural fatigue caused by resonance.

Of course, the relative movement structure between the main housing 32 and the base 33 can take various forms (e.g., rotation, detachable connections, or other movable connection structures). However, the aforementioned structures are provided only as examples, and other structural forms are not listed here one by one.

Furthermore, the bottom of the base 33 is provided with foot pads 42. Four foot pads can be provided, which is merely an example and not a limitation on the specific quantity. The foot pads 42 provide stable placement and anti-slip functionality for the ambient image projection device, reducing vibrations transmitted to the surface when the built-in speaker operates. They also prevent scratches and damage during placement and compensate for uneven placement surfaces.

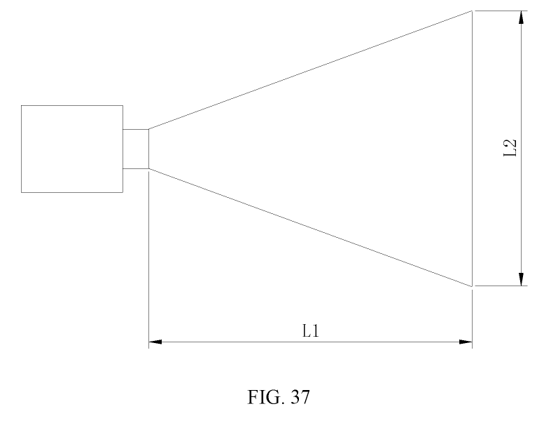

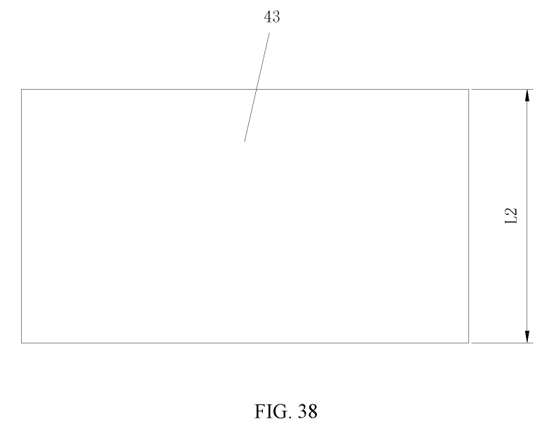

Furthermore, as shown in FIGS. 37 and 38, the projection ratio of the ambient image projection device can be less than or equal to 0.9. The projection ratio refers to the ratio of the projection distance L1 to the width L2 of the projected image, where L2 represents the width of the projected image 43. Thus, the projection ratio is calculated as L1/L2. Additionally, due to variations in the thickness and concave-convex shapes of the lenses, their curvatures differ, resulting in varying refractive indices for light. In the ambient image projection device of the present disclosure, the lens assembly 221' includes the first convex lens 221a, the plano-concave lens 221b', and the second convex lens 221c. The aforementioned projection ratio is achieved through the mutual cooperation among the first convex lens 221a, the plano-concave lens 221b', and the second convex lens 221c, or through the combination of the lens assembly 221' and the distorted lens group 200. Furthermore, the projection focal length can be adjusted by modifying the curvatures of these lenses, thereby adjusting the projection ratio. Specifically, the projection ratio of the ambient image projection device can be adjusted to be less than or equal to 0.9 to achieve desired technical effects of the present disclosure.

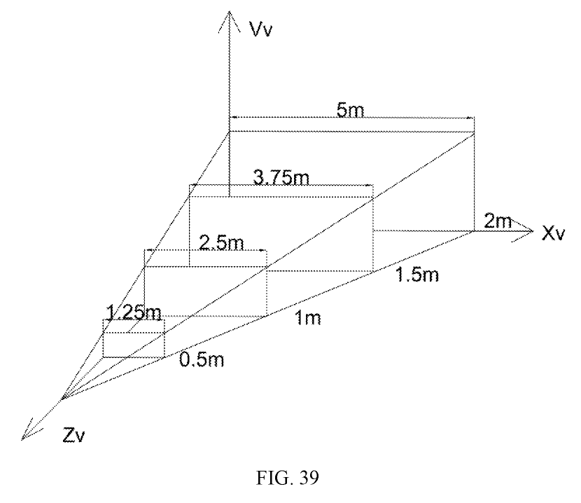

As shown in FIG. 39, in one embodiment, the projection ratio can be less than or equal to 0.4. Specifically, when the projection distance is 0.5m, the width of the projected image is equal to 1.25m; when the projection distance is 1m, the width of the projected image is greater than or equal to 2.5m; when the projection distance is 1.5m, the width of the projected image is greater than or equal to 3.75m; and when the projection distance is 2m, the width of the projected image is greater than or equal to 5m. For an ambient image projection device equipped with a distorted lens group 200, maintaining a projection ratio around 0.4 can achieve optimal technical effects.

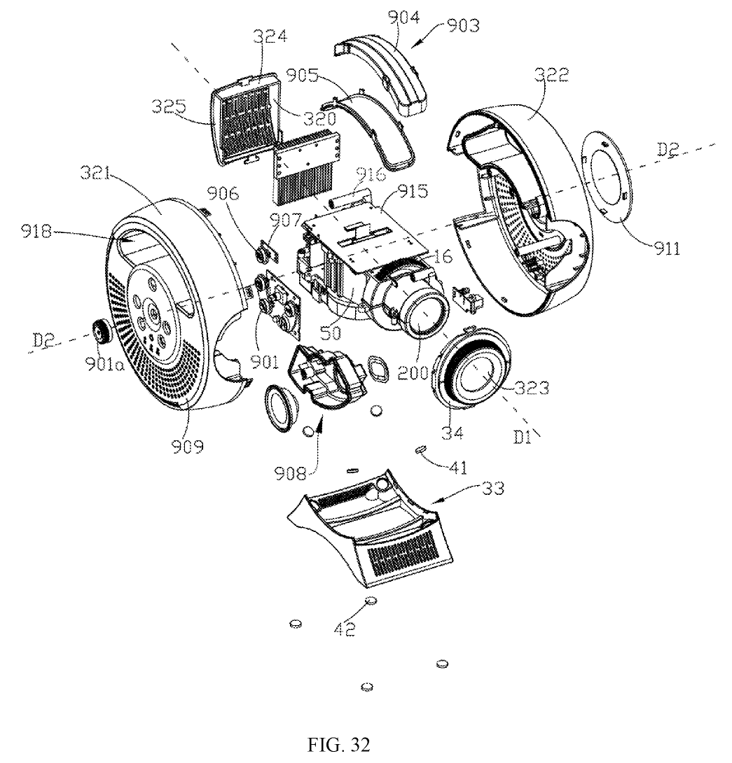

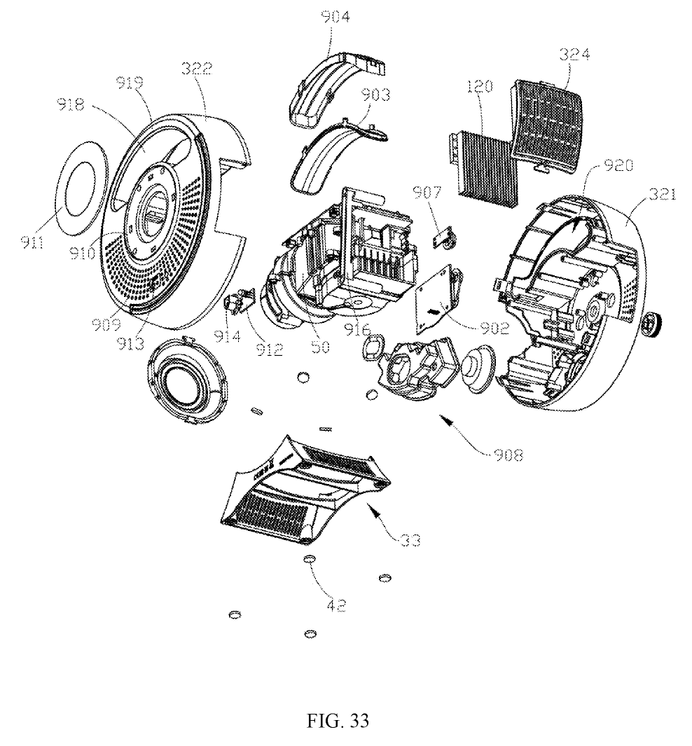

Furthermore, as shown in FIGS. 32 and 33, the left housing 323 and the right housing 322 are arranged and snap-fitted together along the direction D2, which is perpendicular to the optical axis direction D1. In this embodiment, the main housing 32 can be cylindrical, with its central axis aligned along direction D2. Through the first and second sliding structures, the main housing 32 can slide relative to the base 33 around direction D2 to adjust the optical axis direction D1, thereby adjusting the projection angle.

A plurality of control buttons 901 are arranged on one side of the main housing 32. The ambient image projection device further includes a button circuit board 902, which is positioned between the optical engine housing 50 and the multiple control buttons 901. The plane of the button circuit board 902 can be perpendicular to the direction D2. The plurality of control buttons 901 include functions such as forward, backward, pause, play (e.g., single-loop, sequential-loop), and volume adjustment, enabling control over the playback and volume of the ambient projection images. Among the plurality of control buttons 901, there is a stepless adjustment knob 901a, which can be arranged at the center of one side of the main housing 32 for both aesthetic and ease of operation.

In this embodiment, the ambient image projection device further includes a night light module 903, which is positioned on the side of the main housing 32 away from the base 33. The night light module 903 comprises a night light box 904, a night light cover 905, a night light control button 906, and a night light control board 907. The night light control button 906 and the night light control board 907 are correspondingly arranged. The night light control button 906 is installed on one side of the main housing 32 and can be located on the same side as the plurality of control buttons 901, with the night light control button 906 positioned above the multiple control buttons 901. The night light control board 907 is located above the button circuit board 902. The night light box 904 is electrically connected to the night light control board 907 and contains a light-emitting element. When the user operates the night light control button 906, it triggers the night light control board 907 to generate a control signal, which is used to control activation, deactivation, and/or light adjustment of the night light box 904.

The ambient image projection device further includes a speaker module 908 arranged in the lower area of the inner cavity of the main housing 32, such as below the button circuit board 902, and is positioned adjacent to the base 33. Multiple through-holes 909 are provided on the lower sides of both sides of the main housing 32. These through-holes 909 can be configured for heat dissipation and sound transmission. At the center of the outer surface on the side of the main housing 32 away from the plurality of control buttons 901, there is a recess 910, onto which a decorative cover 911 is snap-fitted.

The ambient image projection device further includes an interface circuit board 912. An opening 913 is provided on the side of the main housing 32 away from the plurality of control buttons 901. The interface connectors 914 on the interface circuit board 912 are exposed through the opening 913 to connect with external devices for charging and/or data exchange. The opening 913 can be positioned beneath the decorative cover 911.

The ambient image projection device further includes a main circuit board 915, which can be arranged above the optical engine housing 50 and corresponds to the air inlet 52. This arrangement not only makes the internal structure more compact but also allows some of the heat generated by the main circuit board 915 to be dissipated through the air inlet 52. The main circuit board 915 is electrically connected to the night light control board 907, the button circuit board 902, the interface circuit board 912, the projection assembly 60 (including the light source 11 and the display screen 21), and the first cooling fan 23. A controller on the main circuit board 915 is used to control the night light control board 907, the button circuit board 902, the interface circuit board 912, the projection assembly 60, and the first cooling fan 23.

A mounting bracket 916 can be provided inside the main housing 32. The mounting bracket 916 is configured to secure the optical engine housing 52 to the inner side of the main housing 32. The mounting bracket 916 may include a U-shaped structure that clamps onto at least three sides of the optical engine housing 52. This mounting bracket 916 not only has a simple structure but also provides a good fixing effect, improving the stability of the product.

Furthermore, there is a through opening area 918 on the top of the main housing 32, forming a handle structure 919 above the opening area 918. The night light box 904 is arranged inside the handle structure 919. The handle structure 919 further includes a mounting opening 920 adjacent to the opening area 918, onto which the night light cover 905 is installed. The night light box 904 emits light towards the opening area 918 through the night light cover 905. This lighting design achieves a concealed lighting effect, preventing excessively high light intensity from affecting the projection quality.

Furthermore, in this embodiment, the focusing hole 36 corresponds to the opening area 918, allowing the focusing wheel 16 to protrude through the main housing 32 at the opening area 918. It can be understood that this design positions the focusing wheel 16 in a relatively concealed location, making it less prone to accidental touch and enhancing the user experience.

### Embodiment 15

Based on the previous Embodiment 14, the operational convenience of the ambient image projection device is further enhanced. The details are as follows.

Furthermore, the ambient image projection device further includes a focusing assembly 300, which is configured to be drivable both manually and automatically, so as to drive at least a portion of lenses in the lens assembly 221' to move along the optical path direction, thereby focusing the dynamic image. The focusing assembly supports dual-mode driving (manual and automatic), and achieves precise focusing by changing the physical position of the lens assembly 221', ensuring clear dynamic images at different projection distances and improving the device’s adaptability to various scenarios.

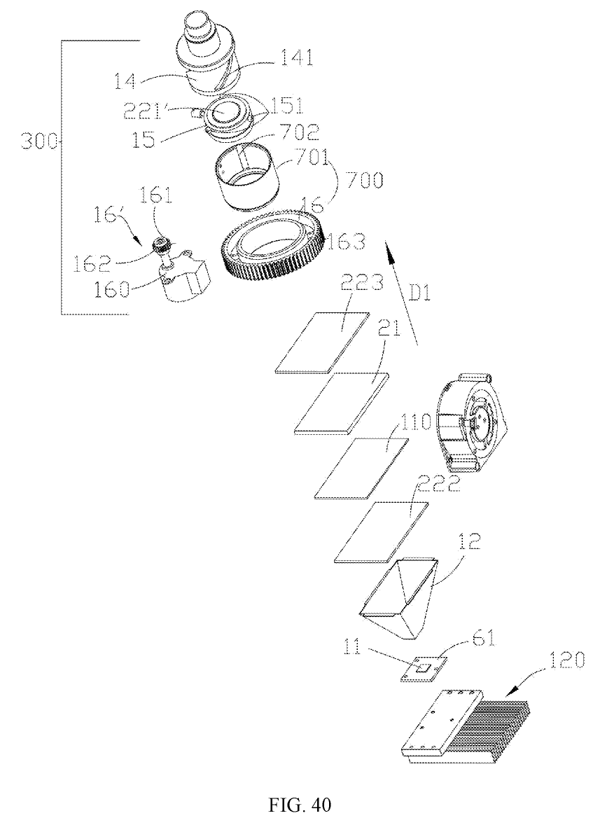

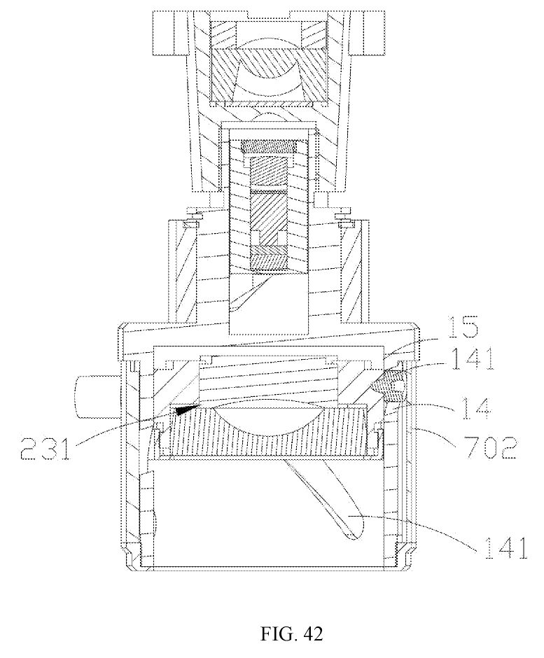

As shown in FIGS. 40 to 42, in this embodiment, when the focusing assembly 300 is configured for manual driving, it includes a fixed base member 14, at least one movable lens barrel 15, and an external drive assembly 700. At least a portion of the lenses of the lens assembly 221' are fixedly mounted inside the movable lens barrel 15. The at least one movable lens barrel 15 and the external drive assembly 700 are both assembled on the fixed base member 14. The at least one movable lens barrel 15 is capable of sliding linearly relative to the fixed base member 14 along the optical path direction, and the external drive assembly 700 is capable of rotating relative to the fixed base member 14 and is in transmission connection with the movable lens barrel 15.

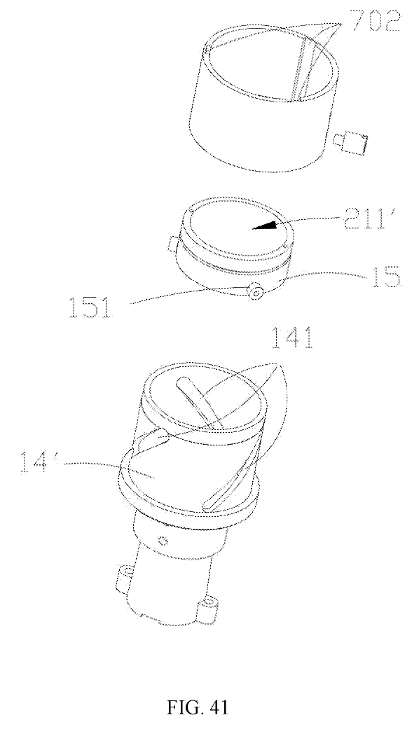

The above-mentioned Embodiment 5 describes that “the outer surface of the movable lens barrel 15 may be provided with an external thread, and the inner surface of the focusing ring 16 is provided with an internal thread matching the external thread, so that by rotating the focusing ring 16, the movable lens barrel 15 can be driven to move the lens assembly 221' back and forth along the optical path direction D1 for focusing”. Furthermore, on the basis of Embodiment 5, this embodiment replaces the threaded rotation method with a guiding opening 141 to guide the rotation. As shown in FIGS. 40 and 41, specifically, as a preferred embodiment, the fixed base member 14 is a fixed guide cylinder, and the wall of the fixed guide cylinder is provided with at least one oblique guide opening 141. The external drive assembly 700 is sleeved on the outside of the fixed guide cylinder. The external drive assembly 700 is generally annular, and on its inner wall adjacent to the fixed guide cylinder, there is provided an axially extending straight groove 702. The movable lens barrel 15 is arranged inside the fixed guide cylinder, and an insertion post 151 is fixed on the outer wall of the movable lens barrel 15. The insertion post 151 passes outward through the guide opening 141 and snaps into the straight groove 702, such that when the external drive assembly 700 rotates, the straight groove 702 moves the insertion post 151 to slide along the oblique trajectory of the guide opening 141. By utilizing the mechanical cooperation of the straight groove, the oblique guide opening, and the insertion post, the rotational motion of the external drive assembly 700 is converted into axial linear translation of the movable lens barrel 15. This transmission structure can control the lens movement stroke and effectively reduces friction resistance, providing a smooth manual mechanical focusing experience.

As shown in FIG. 40, in this embodiment, when the focusing assembly 300 is configured for automatic driving, it includes the external drive assembly 700, and a second meshing structure 163 is fixed on the outer surface of the external drive assembly 700. The ambient image projection device further includes a main circuit board 915 and a drive motor 160 electrically connected to the main circuit board 915. The main circuit board 915 is integrated with a controller 6. An output shaft 161 of the drive motor 160 is provided with a first meshing structure 162 that meshes with the second meshing structure 163. The controller 6 is configured to output control signals to control the drive motor 160 to rotate forward or reverse, thereby driving the external drive assembly 700 to automatically rotate and move the lenses along the optical path direction. Without changing the underlying mechanical focusing optical path, the introduction of a transmission meshing structure (the first meshing structure 162 and the second meshing structure 163) and the drive motor endows automatic execution capability. The main circuit board sends control commands to drive the motor to rotate precisely, realizing efficient automatic focusing of the optical engine system and facilitating user operation. The first meshing structure 162 is a drive gear, and the second meshing structure 163 is a transmission gear.

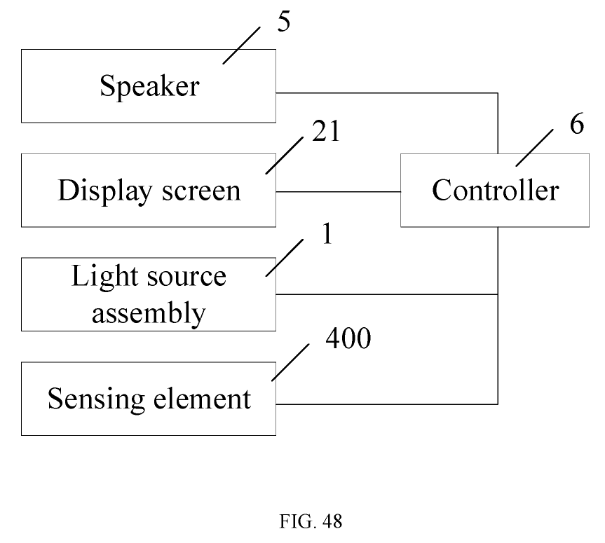

As shown in FIG. 48, additionally, the ambient image projection device further includes a sensing element 400 electrically connected to the main circuit board 915. The sensing element 400 is arranged on the side of the projection device facing the projection surface, and is used to collect projection distance data in the space or image sharpness data of the projected image in real time, and to transmit the projection distance data to the controller 6. The controller 6 has a preset focusing algorithm, and based on the received data, calculates a focus compensation amount and dynamically adjusts the control signals sent to the drive motor 160 until the projected image reaches a preset sharpness, thereby completing automatic focusing. Through the sensing element 400 obtaining environmental physical data in real time, combined with the focusing algorithm of the controller 6, a complete automatic focusing closed-loop feedback system is established. This enables the projection device to perceive the environment and adaptively feedback and adjust according to different projection distances and wall conditions, ensuring focusing accuracy.

As shown in FIG. 40, the above-mentioned external drive assembly includes a drive ring 701 sleeved on the outside of the fixed guide cylinder, and a focusing ring 16 sleeved on the outside of the drive ring 701. The focusing ring 16 is circumferentially fixedly connected to the drive ring 701. The straight groove 702 is provided on the inner wall of the drive ring 701, so that when the focusing ring 16 rotates, it drives the drive ring 701 to rotate synchronously. The outer peripheral surface of the focusing ring 16 is provided with the second meshing structure 163. At least a portion of the focusing ring 16 is exposed to the outside of the main housing 32 through the extension hole for manual rotation by the user, and the transmission ring gear 163 is used to mesh with the drive motor 160 in the automatic drive system.

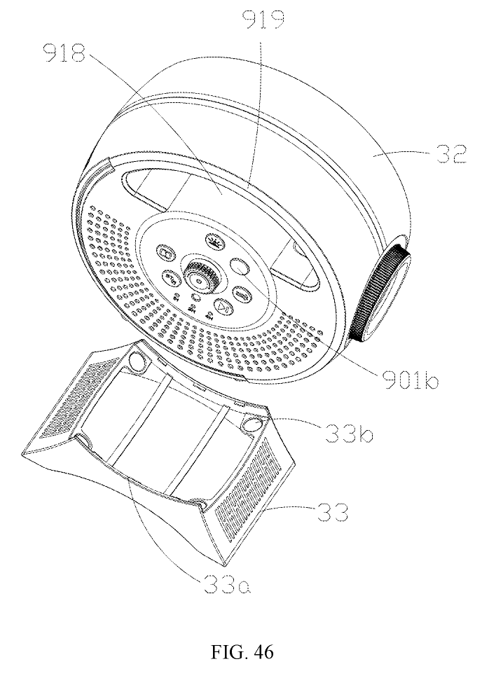

As shown in FIG. 46, further, a focus mode switch button 901b electrically connected to the button circuit board 902 is provided on the side wall of the main housing 32, and the focus mode switch button 901b is exposed to the outside of the main housing 32. The focus mode switch button 901b is configured to generate a mode switching signal in response to a user operation, and to send it to the controller 6, so that the controller 6 switches between the manual focusing mode of the drive motor 160 and the automatic focusing mode of the drive motor 160. The dedicated physical switching button allows the user to flexibly switch to manual mode for mechanical fine adjustment according to specific usage environments, for example, when automatic focusing fails due to lack of contrast on the wall. This greatly improves the overall reliability of the device.

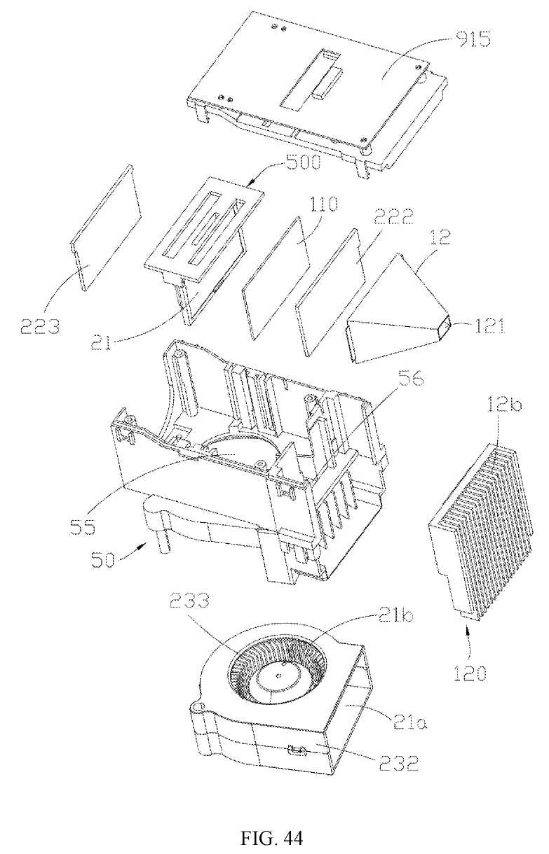

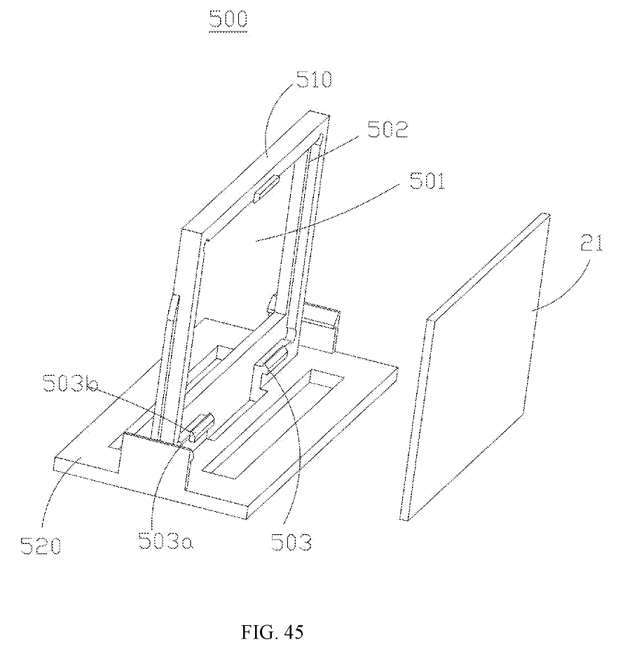

As shown in FIGS. 44 and 45, in this embodiment, the first projection mechanism 2 further includes a fixing frame bracket 500 for fixing the display screen 21. A projection opening 501 for transmitting projection light is provided in the middle of the fixing frame bracket 500. On one side around the projection opening 501, the fixing frame bracket 500 is recessed to form a placement groove 502 for accommodating the display screen 21. On the fixing frame bracket 500 and adjacent to the placement groove 502, a plurality of stoppers 503 are protruded for limiting the display screen 21. The display screen 21 is embedded in the placement groove 502 and fixedly limited by the plurality of stoppers 503. With the fixing frame bracket 500, the placement groove 502, and the plurality of stoppers 503, screwless quick assembly of the display screen is achieved.

As shown in FIG. 45, further, the fixing frame bracket 500 includes a screen carrying frame 510 and a frame support base 520. The placement groove 502 is provided on the screen carrying frame 510, and the screen carrying frame 510 is mounted on the frame support base 520. The projection opening 501, the placement groove 502, and the stoppers 503 are all provided on the screen carrying frame 510. By dividing the fixing bracket into two parts, the screen carrying frame 510 and the frame support base 520, the display screen module can be independently assembled and modularly plugged, facilitating segmented assembly on the production line and later rapid maintenance.

As shown in FIG. 45, further, the plurality of stoppers 503 are distributed on two opposite sides of the placement groove 502. Each stopper 503 includes a guiding inclined surface 503a facing the opening direction of the placement groove 502, and a limiting surface 503b facing the bottom surface of the placement groove 502. When assembling the display screen 21, the edge of the display screen 21 can be pressed to slide along the guiding inclined surface 503a and pass over the stopper 503, so that the limiting surface 503b snaps and fixes the display screen 21 in the placement groove 502. With the transitional effect of the guiding inclined surface, the display screen can be smoothly pressed in during assembly, and after assembly, it is vertically blocked by the limiting surface and cannot be reversely pulled out. This anti-disengagement design not only ensures the stability of screen assembly but also minimizes the structural volume inside the optical engine.

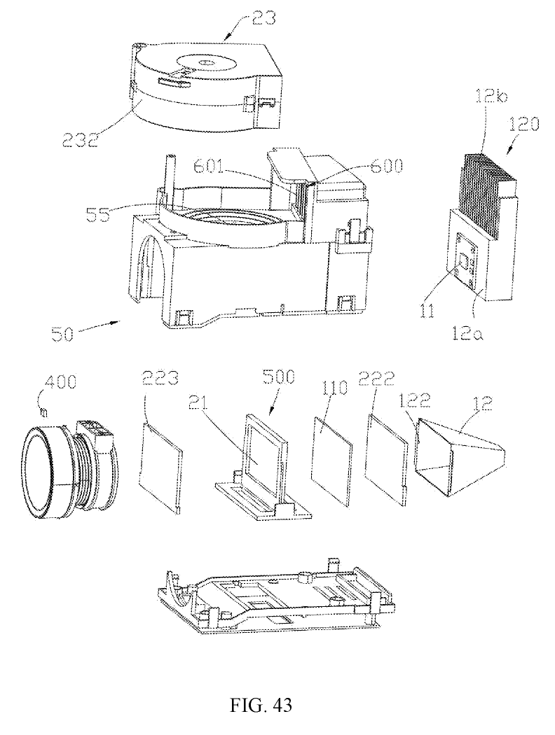

As shown in FIGS. 43 and 44, this embodiment further includes a heat dissipation system. The lens assembly 221' is installed inside the optical engine housing 50. The optical engine housing 50 is provided with an air passage opening 55 on a side wall and a mounting opening 56 on an adjacent side wall. The heat dissipation system includes a first cooling fan 23, an air guide member 600, and a heat sink 120. The first cooling fan 23 is arranged outside the optical engine housing 50 and at the air passage opening 55. The first light source 11 is fixedly attached to a side of the heat sink 120 facing the mounting opening 56, and the first light source 11 is located outside the optical engine housing 50 and corresponding to the mounting opening 56. The light emitted by the first light source 11 enters the interior of the optical engine housing 50 through the mounting opening 56. The air guide member 600 is connected between the air outlet of the first cooling fan 23 and the heat sink 120. By placing the first light source 11, which generates the most heat, outside the main cavity of the optical engine housing 50, cool air blown by the first cooling fan 23 can flow directly through the air guide member 600 to the heat sink 120, carrying away the heat generated by the first light source during operation. This prevents high-temperature heat from entering the interior of the optical engine housing 50 and affecting the operational stability of other optical elements. At the same time, there is no need to reserve additional heat dissipation space inside the main optical engine cavity, which optimizes internal space utilization and avoids heat dissipation airflow disturbance affecting the stability of the imaging optical path. In addition, disposing the heat dissipation system outside reduces the cavity volume inside the optical engine housing 50, allowing a more compact layout of optical components, thereby reducing the overall size of the device.

As shown in FIG. 44, further, the first cooling fan 23 has an axial air inlet 21b and a lateral air outlet 21a. The axial air inlet 21b is arranged corresponding to the air passage opening 55. The air inlet end of the air guide member 600 abuts the lateral air outlet 21a of the first cooling fan 23, and the air outlet end of the air guide member 600 faces the heat sink 120. By using a centrifugal cooling fan with a laterally connected air guide member 600, airflow can be delivered within the limited and compact device structure space. The drawn-in cool air is forced to be transported laterally to the heat sink area, greatly optimizing the space utilization of the overall air duct.

As shown in FIG. 43, further, the air guide member 600 is provided with a plurality of air guide vanes 601. The plurality of air guide vanes 601 are used to guide the airflow toward the heat sink 120. The air guide vanes 601 direct the high-speed airflow to avoid turbulence or unnecessary leakage during transport, increase the airflow speed passing through the heat sink, enhance overall heat dissipation efficiency, ensure that the operating temperature of the first light source 11 is always maintained within a reasonable range, and extend the service life of the first light source 11.

As shown in FIGS. 43 and 44, further, the heat sink 120 includes a base plate 12a and heat dissipation fins 12b. The base plate 12a is mounted on the side of the heat dissipation fins 12b facing the light emission direction. The first light source 11 is mounted on the base plate 12a. The air guide member 600 is arranged in parallel with the first light source 11, and the air guide member 600 is aligned with the heat dissipation fins 12b. With this structure, the heat generated by the first light source 11 can be quickly conducted to the heat dissipation fins through the base plate, and the cool air delivered by the air guide member 600 passes directly through the gaps of the heat dissipation fins 12b to remove heat, preventing heat from accumulating around the optical engine housing 50. The heat dissipation path is short and direct, further improving heat dissipation efficiency, preventing the first light source 11 from experiencing light degradation due to high temperature, and ensuring the brightness stability of the projected image.

With reference to FIGS. 37 to 39, in combination with Embodiment 14, which mentions that the projection ratio of the ambient image projection device can be less than or equal to 0.9, in this implementation, further, the projection ratio of the ambient image projection device is preferably less than or equal to 0.7. A smaller projection ratio means that the device can project a larger image at a shorter projection distance, suitable for most small and medium-sized home spaces. Even if the user places the projection device on a TV cabinet very close to the wall, a large projected image meeting viewing needs can be obtained, without deliberately adjusting the device placement to achieve a large image. This further improves the device’s spatial adaptability and better meets the needs of small-apartment households. The calculation method for the projection ratio has been described above and will not be repeated here.

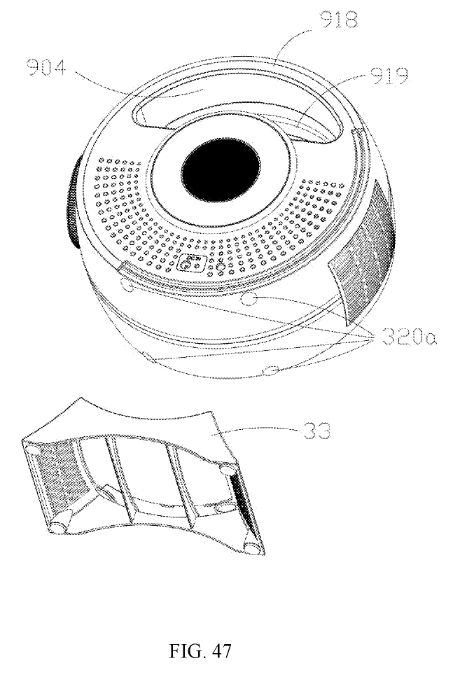

As shown in FIGS. 46 and 47, in combination with Embodiment 14, further, the upper part of the main housing 32 is provided with a through opening area 918, so that the top of the main housing 32 forms a handle structure 919. The ambient image projection device further includes a night light module 903 arranged on the side of the main housing 32 facing away from the base 33 and is arranged inside the handle structure 919. The night light module 903 includes a night light control board 907, a night light box 904 electrically connected to the night light control board 907, and a night light control button 906. The night light control button 906 is provided on the outer wall of one side of the main housing 32, and is arranged on the same side as the focus mode switch button 901b. The night light box 904 is internally provided with light-emitting elements, and the night light box 904 is configured to emit light downward toward the opening area 918. The handle structure combines ergonomic grip with concealed storage of the night light. The downward light emission design of the night light box produces a soft diffused light effect, avoiding glare from direct viewing; moreover, the control buttons are arranged on the same side of the housing, making it convenient for the user to complete focus switching and lighting control with one hand, improving the interactive experience.

As shown in FIGS. 46 and 47, as described in Embodiment 14, the ambient image projection device further includes a base 33 arranged under the bottom of the main housing 32. The bottom outer surface of the main housing 32 is provided with a plurality of downwardly protruding supporting feet 320a. The top of the base 33 has a receiving arc surface 33a matching the bottom of the main housing 32, and the receiving arc surface 33a is recessed with a plurality of positioning grooves 33b corresponding in number and position to the supporting feet 320a. When the main housing 32 is placed on the base 33, the plurality of supporting feet 320a are respectively fitted into the corresponding positioning grooves 33b. This facilitates positioning and installation of the main body of the projection device, preventing accidental sliding or displacement of the main housing 32 on the receiving arc surface 33a. At the same time, the fitting structure of the supporting feet 320a and the positioning grooves 33b does not affect quick disassembly and assembly of the main housing 32. The user can remove the main housing from the base according to usage needs, change the placement mode, or carry it around, adapting to different usage scenarios.

As shown in FIG. 11, as described in Embodiment 6, the front end inside the optical engine housing 50 is provided with a card slot 19 matching the fixed base member 14, and the fixed base member 14 is snap-fitted and fixed in the card slot 19.

With regard to the specific structure of the light-concentrating element 12 (such as the surrounding wall and the arrangement relationship between the light inlet 121 and the light outlet 122), the distortion lens group 200 arranged on the light exit side of the lens assembly 221' for processing edge images, the limiting structure 18 arranged inside the front end of the optical engine housing 50 for ensuring a safe distance between the lenses, the card slot 19 and positioning structure (such as the specific assembly of the positioning hole and the positioning post 20) between the fixed base member 14 and the optical engine housing 50, the focusing aperture 36 for the focusing wheel 16 to pass therethrough, and the sliding structure between the main housing 32 and the base 33 for adjusting the projection image (including the projection aperture 34, the side wall 38, the detailed sliding mechanism of the cooperation between the first sliding structure and the second sliding structure) — their specific mechanical structures, connection and assembly relationships, and corresponding technical effects have been clearly and fully described in the above-mentioned embodiments. This embodiment further expands on the basis of being compatible with the above structures. The specific details not fully described can directly follow relevant descriptions in the foregoing sections and will not be repeated here.

The above-described embodiments merely illustrate several embodiments of the present disclosure, and the description thereof is relatively specific and detailed, but it should not be construed as limiting the scope of patent protection. It should be pointed out that, for ordinary skilled in the art, several modifications and improvements can be made without departing from the concept of the present disclosure, which all fall within the scope of protection of the present disclosure. Therefore, the protection scope of the present disclosure should be determined by appended claims.

What is claimed is:

1. An ambient image projection device, comprising:
a lens assembly;
a projection assembly, comprising a first light source and a display screen; content played on the display screen is capable of forming a dynamic image under guidance of the lens assembly and projecting the dynamic image into space; and
a focusing assembly, configured to be drivable both manually and automatically, so as to drive at least a portion of lenses in the lens assembly to move along an optical path direction, thereby focusing the dynamic image;
wherein the first light source, the display screen, and the lens assembly are sequentially arranged along an optical path of the ambient image projection device, and the display screen is arranged on a light-exiting side of the first light source.

2. The ambient image projection device according to claim 1, wherein when the focusing assembly is configured for manual driving, the focusing assembly comprises a fixed base member, at least one movable lens barrel, and an external drive assembly; at least a portion of lenses of the lens assembly are fixedly mounted inside the movable lens barrel; the at least one movable lens barrel and the external drive assembly are both assembled on the fixed base member, the at least one movable lens barrel is capable of sliding linearly relative to the fixed base member along the optical path direction, the external drive assembly is capable of rotating relative to the fixed base member, and the external drive assembly is in transmission connection with the movable lens barrel.

3. The ambient image projection device according to claim 2, wherein the fixed base member is a fixed guide cylinder, and a wall of the fixed guide cylinder is provided with at least one oblique guide opening; the external drive assembly is sleeved on an outside of the fixed guide cylinder, the external drive assembly is annular, and an inner wall of the external drive assembly adjacent to the fixed guide cylinder is provided with an axially extending straight groove; the movable lens barrel is arranged inside the fixed guide cylinder, and an insertion post is fixedly provided on an outer wall of the movable lens barrel; the insertion post passes through the guide opening and snaps into the straight groove, such that rotation of the external drive assembly is capable of enabling the straight groove to guide the insertion post to slide along an oblique trajectory of the guide opening.

4. The ambient image projection device according to claim 1, wherein when the focusing assembly is configured for automatic driving, the ambient image projection device further comprises a main circuit board and a drive motor electrically connected to the main circuit board, and a controller is integrated on the main circuit board;
a first meshing structure is provided on an output shaft of the drive motor; the focusing assembly comprises an external drive assembly and a second meshing structure is fixedly provided on an outer surface of the external drive assembly and is in mesh with the first meshing structure; and the controller is configured to output control signals to control the drive motor to rotate forward or reverse, thereby driving the external drive assembly to rotate automatically to drive the lenses of the lens assembly to move along the optical path direction.

5. The ambient image projection device according to claim 4, further comprising a sensing element electrically connected to the main circuit board; the sensing element is arranged on a side of the projection device facing a projection surface, and is configured to collect projection distance data in space and image sharpness data of a projected image, and to transmit collected data to the controller; the controller is configured to determine a focus compensation amount based on the collected data and to dynamically adjust the control signals sent to the drive motor until the projected image reaches a preset sharpness, thereby completing automatic focusing.

6. The ambient image projection device according to claim 5, further comprising a main housing and a button circuit board arranged inside the main housing, the button circuit board being in communication connection with the main circuit board; wherein a focus mode switch button electrically connected to the button circuit board is provided on a side wall of the main housing and is exposed outside the main housing; the focus mode switch button is configured to generate a mode switching signal in response to a user operation and to send the mode switching signal to the controller, so that the controller is capable of switching between a manual focusing mode and an automatic focusing mode.

7. The ambient image projection device according to claim 1, wherein the projection assembly further comprises a fixing frame bracket configured to fix the display screen, a middle portion of the fixing frame bracket is provided with a projection opening for transmitting projection light; on one side around the projection opening, the fixing frame bracket is recessed to form a placement groove configured to accommodate the display screen, and on the fixing frame bracket adjacent to the placement groove, a plurality of stoppers are arranged and configured to limit the display screen; and the display screen is embedded in the placement groove and fixedly limited by the plurality of stoppers.

8. The ambient image projection device according to claim 7, wherein the fixing frame bracket comprises a screen carrying frame and a frame support base; the placement groove is provided on the screen carrying frame, and the screen carrying frame is mounted on the frame support base.

9. The ambient image projection device according to claim 7, wherein the plurality of stoppers are distributed on two opposite sides of the placement groove;
each stopper comprises a guiding inclined surface facing an opening direction of the placement groove, and a limiting surface facing a bottom surface of the placement groove; an edge of the display screen is capable of being pressed to slide along the guiding inclined surface and pass over the stopper, so that the limiting surface snaps and fixes the display screen in the placement groove.

10. The ambient image projection device according to claim 1, further comprising a heat dissipation system and an optical engine housing; the lens assembly is installed inside the optical engine housing; the optical engine housing is provided with an air passage opening and a mounting opening provided on a side wall of the optical engine housing adjacent to a side wall of the optical engine housing where the air passage opening is located;
the heat dissipation system comprises a first cooling fan, an air guide member, and a heat sink, wherein the first cooling fan is arranged outside the optical engine housing and corresponding to the air passage opening, the first light source is fixedly attached to a side of the heat sink facing a light emission direction thereof, the first light source is located outside the optical engine housing and corresponding to the mounting opening, light emitted by the first light source is capable of entering the housing through the mounting opening, and the air guide member is connected between an air outlet of the first cooling fan and the heat sink; the first cooling fan is configured to draw air from inside the optical engine housing and blow it out from a side facing the air guide member, and the air guide member is configured to guide the airflow blown out by the first cooling fan to the heat sink, thereby carrying away the heat from the first light source.

11. The ambient image projection device according to claim 10, wherein the first cooling fan has an axial air inlet and a lateral air outlet, the axial air inlet is arranged corresponding to the air passage opening; an air inlet end of the air guide member abuts the lateral air outlet of the first cooling fan, and an air outlet end of the air guide member faces the heat sink.

12. The ambient image projection device according to claim 10, wherein the air guide member is provided with a plurality of air guide vanes configured to guide a flow direction of airflow from the first cooling fan toward the heat sink.

13. The ambient image projection device according to claim 10, wherein the heat sink comprises a base plate and heat dissipation fins; the base plate is mounted on a side of the heat dissipation fins facing the light emission direction, the first light source is mounted on the base plate, the air guide member is arranged in parallel with the first light source, and the air guide member corresponds to the heat dissipation fins.

14. The ambient image projection device according to claim 1, wherein a projection ratio of the ambient image projection device is less than or equal to 0.7, and the projection ratio is a ratio of a projection distance of the dynamic image to a width of a projected image.

15. The ambient image projection device according to claim 10, wherein the projection assembly further comprises a light-concentrating element, the light-concentrating element is installed in the optical engine housing, the light-concentrating element comprises a light inlet and a light outlet, the light outlet is aligned with the mounting opening, the display screen is configured to obtain light from the light outlet, the light-concentrating element comprises a surrounding wall, and at least a portion of an inner diameter of the surrounding wall gradually increases from the light inlet toward the light outlet.

16. The ambient image projection device according to claim 6, wherein an upper portion of the main housing is provided with a through opening area, so that a top of the main housing forms a handle structure;
the ambient image projection device further comprises a night light module, the night light module is arranged on a side of the main housing facing away from a base supporting the main housing and is arranged inside the handle structure;
the night light module comprises a night light control board, a night light box electrically connected to the night light control board, and a night light control button; the night light control button is provided on an outer wall of one side of the main housing and is arranged on the same side as the focus mode switch button; the night light box is internally provided with light-emitting elements, and the night light box is configured to emit light downward toward the through opening area.

17. The ambient image projection device according to claim 6, further comprising a base configured to support the main housing from below;
a plurality of supporting feet protrude downward from a bottom outer surface of the main housing; a top of the base has a receiving arc surface matching a bottom of the main housing, and the receiving arc surface is recessed to form a plurality of positioning grooves corresponding in number and position to the supporting feet; and
when the main housing is placed on the base, the plurality of supporting feet are respectively fitted into the corresponding positioning grooves.

18. The ambient image projection device according to claim 2, further comprising an optical engine housing and a distortion lens assembly arranged on a light-exiting side of the optical lens, wherein the fixed base member and the movable lens barrel are both installed inside the optical engine housing; and
a limiting structure is provided inside a front end of the optical engine housing, and when the movable lens barrel moves along the optical path direction to abut against the limiting structure, a preset safe distance is maintained between a front end of the movable lens barrel and the distortion lens group.

19. The ambient image projection device according to claim 18, wherein a front end inside the optical engine housing is provided with a card slot matching the fixed base member, and the fixed base member is snap-fitted and fixed in the card slot.

20. The ambient image projection device according to claim 18, further comprising an outer housing, the optical engine housing being arranged inside the outer housing; the outer housing comprises a main housing and a base located below the main housing, the main housing is movably arranged on the base; a front end of the main housing is provided with a projection aperture arranged corresponding to the distortion lens assembly and configured to allow light to be emitted out of the main housing through the projection aperture.
